(19) United States
(12) Patent Application Publication
(10) Pub. No.: US 2024/0287258 A1
(43) Pub. Date: Aug. 29, 2024

(54) POLYCARBONATE RESIN COMPOSITION AND MOLDED ARTICLE

(71) Applicant: IDEMITSU KOSAN CO., LTD., Tokyo (JP)

(72) Inventors: Minoru YABUKAMI, Ichihara-shi, Chiba (JP); Yuto HANIOKA, Chiba-shi, Chiba (JP); Nobuhiro WATANABE, Chiba-shi, Chiba (JP); Toshio ISOZAKI, Chiba-shi, Chiba (JP)

(73) Assignee: IDEMITSU KOSAN CO., LTD., Tokyo (JP)

(21) Appl. No.: 18/567,752

(22) PCT Filed: Jun. 8, 2022
(86) PCT No.: PCT/JP2022/023110

§ 371 Date: Dec. 6, 2023

(30) Foreign Application Priority Data
Jun. 9, 2021 (JP) 2021-096795

(51) Int. Cl. C08G 77/448; C08K 5/103

(52) U.S. Cl. CPC C08G 77/448; C08K 5/103

(57) ABSTRACT

The present invention provides: [1] a polycarbonate-based resin composition including: a polycarbonate-based resin (S) containing a polycarbonate-polyorganosiloxane copolymer (A) having a polyorganosiloxane block (A-1) including a specific structural unit and a polycarbonate block (A-2) including a specific structural unit; and a release agent (B); and [2] a molded body including the polycarbonate-based resin composition according to the above-mentioned item [1].

### TECHNICAL FIELD

The present invention relates to a polycarbonate-based resin composition and a molded body.

### BACKGROUND ART

A polycarbonate-polyorganosiloxane copolymer has been attracting attention because its properties, such as impact resistance, chemical resistance, and flame retardancy, are satisfactory. Accordingly, it has been expected that the copolymer is widely utilized in various fields including an electrical and electronic equipment field, and an automobile field.

Technologies each concerning such polycarbonate-polyorganosiloxane copolymer are, for example, those described in PTLs 1 and 2.

In PTL 1, there is a description of a method of producing a polysiloxane/polycarbonate block co-condensation product, the method including causing (a) a hydroxyaryloxy-terminated dimethylsiloxane and (b) an oligocarbonate, which has a weight-average molecular weight of from 3,000 to 24,000, and a molar ratio between a OH terminal group and an aryl terminal group of from 10:90 to 70:30, to react with each other under molten states at a weight ratio between the (a) and the (b) between 1:99 and 40:60, a temperature of from 250° C. to 320° C., and a pressure of from 0.01 millibar to 100 millibars.

In PTL 2, there is a description of a method for the production of a polysiloxane-polycarbonate block co-condensate including causing a polydialkylsiloxane having at least one kind of hydroxyaryl terminal to react with at least one kind of polycarbonate in a melt, the method being performed through at least two steps in the combination of reactors formed of at least one preliminary reactor, a high-viscosity reactor, and a discharger.

### CITATION LIST

### Patent Literature

PTL 1: JP 10-251408 A
PTL 2: JP 2016-532733 T

### SUMMARY OF INVENTION

### Technical Problem

An investigation made by the inventors of the present invention has revealed that a polycarbonate-based resin composition, which is obtained by blending such a polycarbonate-polyorganosiloxane copolymer obtained by using a polyorganosiloxane having an aryl terminal as described in each of, for example, PTLs 1 and 2 with a release agent is susceptible to improvement in terms of balance between its mechanical strength and releasability.

The present invention has been made in view of the above-mentioned circumstances, and provides a polycarbonate-based resin composition that can provide a molded body improved in balance between its mechanical strength and releasability.

Further, the present invention provides a polycarbonate-based resin molded body improved in balance between its mechanical strength and releasability.

### Solution to Problem

The inventors of the present invention have found that a polycarbonate-based resin composition including a polycarbonate-polyorganosiloxane copolymer (A) having a specific structure and a release agent (B) can provide a molded body improved in balance between its mechanical strength and releasability.

That is, according to the present invention, there are provided the following polycarbonate-based resin composition and molded body.
[1] A polycarbonate-based resin composition, comprising: a polycarbonate-based resin (S) containing a polycarbonate-polyorganosiloxane copolymer (A) having a polyorganosiloxane block (A-1) including a structural unit represented by the formula (1) and a polycarbonate block (A-2) including a structural unit represented by the formula (2); and a release agent (B):

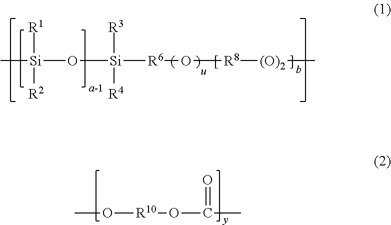

wherein R¹ to R⁴ each independently represent a hydrogen atom, a halogen atom, an alkyl group having 1 to 10 carbon atoms, an alkoxy group having 1 to 10 carbon atoms, an aryl group having 6 to 12 carbon atoms, or an alkylaryl group having 7 to 22 carbon atoms, R⁶ represents an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, a plurality of R⁸s may be identical to or different from each other, and each represent an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, R¹¹¹ represents an alkyl group having 1 to 10 carbon atoms, or an aryl group having 6 to 10 carbon atoms, “z” and “u” each represent 0 or 1, “a” represents an integer of from 2 to 500, “b” represents an integer of from 2 to 200, R¹⁰ represents a divalent aliphatic hydrocarbon group having 2 to 40 carbon atoms, a divalent alicyclic hydrocarbon group having 3 to 40 carbon atoms, or a divalent aromatic hydrocarbon group having 6 to 20 carbon atoms, and these groups may each be substituted with a substituent, and may each contain at least one atom selected from the group consisting of: an oxygen atom; a nitrogen atom; a sulfur atom; and a halogen atom, and “y” represents an integer of from 10 to 500.
[2] The polycarbonate-based resin composition according to the above-mentioned item [1], wherein the polycarbonate block (A-2) includes at least one of a structure unit represented by the formula (111) or a structure unit represented by the formula (112):

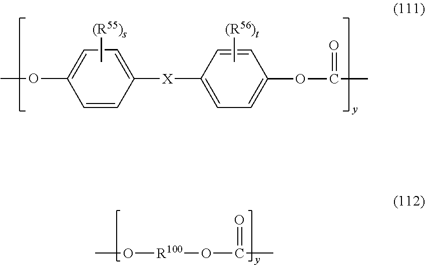

wherein R⁵⁵ and R⁵⁶ each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, an arylene group having 6 to 20 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R¹⁰⁰ represents a divalent aliphatic hydrocarbon group having 2 to 40 carbon atoms, and the divalent aliphatic hydrocarbon group may include at least one selected from the group consisting of: a branched structure; and a cyclic structure, and may contain at least one atom selected from the group consisting of: an oxygen atom; a nitrogen atom; a sulfur atom; and a halogen atom, “y” represents an integer of from 10 to 500, and “s” and “t” each independently represent an integer of from 0 to 4.
[3] The polycarbonate-based resin composition according to the above-mentioned item [1] or [2], wherein the polycarbonate block (A-2) includes a structural unit derived from at least one compound selected from the group consisting of: 2,2-bis(4-hydroxyphenyl)propane; 2,2-bis(4-hydroxy-3-methylphenyl)propane; 1,1-bis(4-hydroxyphenyl)cyclohexane; 1,1-bis(4-hydroxyphenyl)-3-methylcyclohexane; 1,1-bis(4-hydroxyphenyl)-3,3,5-trimethylcyclohexane; 1,1-bis(4-hydroxyphenyl)cyclododecene; isosorbide; cyclohexane-1,4-dimethanol; tricyclodecanedimethanol; 3,9-bis(1,1-dimethyl-2-hydroxyethyl)-2,4,8,10-tetraoxaspiro[5.5]undecane; 1,3-propanediol; and 1,4-butanediol.
[4] The polycarbonate-based resin composition according to any one of the above-mentioned items [1] to [3], wherein the polycarbonate block (A-2) includes at least one selected from the group consisting of structural units represented by the formulae (a-i) to (a-v).

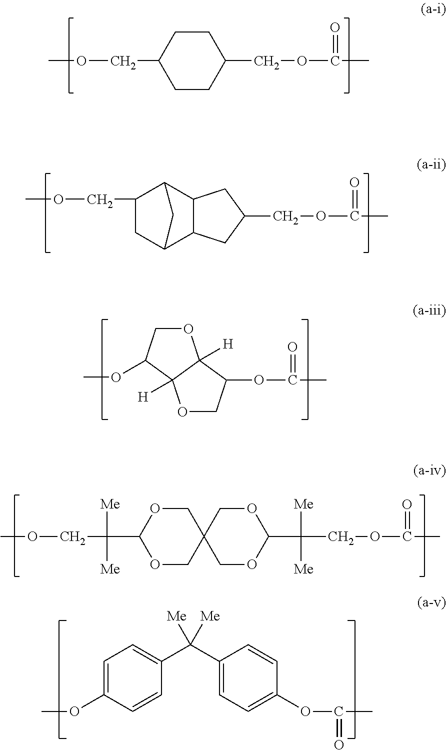

[5] The polycarbonate-based resin composition according to any one of the above-mentioned items [1] to [4], wherein the “a” represents an integer of 2 or more and 300 or less.
5 [6] The polycarbonate-based resin composition according to any one of the above-mentioned items [1] to [5], wherein the “b” represents 10 or more.
[7] The polycarbonate-based resin composition according to any one of the above-mentioned items [1] to [6], wherein the polyorganosiloxane block (A-1) includes at least one selected from the group consisting of structural units represented by the formulae (1-1) to (1-3):

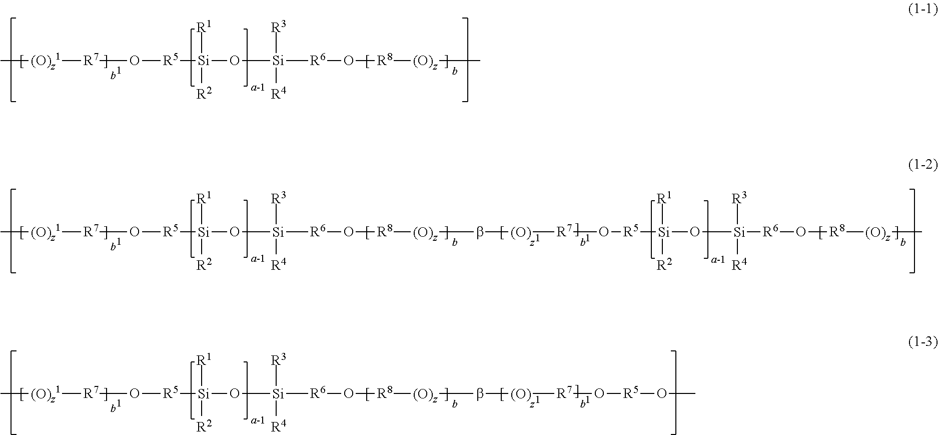

wherein R¹ to R⁴, R⁶, R⁸, “z”, “a”, and “b” each represent the same meaning as that described above, R⁵ represents an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, R⁷ represents an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, R¹¹¹ represents an alkyl group having 1 to 10 carbon atoms, or an aryl group having 6 to 10 carbon atoms, z¹ represents 0 or 1, b1 represents an integer of from 2 to 200, and 8 represents a divalent group derived from a diisocyanate compound, or a divalent group derived from a dicarboxylic acid or a dicarboxylic acid halide.
[8] The polycarbonate-based resin composition according to any one of the above-mentioned items [1] to [7], wherein all of the R¹ to the R¹ represent methyl groups.
[9] The polycarbonate-based resin composition according to any one of the above-mentioned items [1] to [8], wherein the R⁶ represents a trimethylene group.
[10] The polycarbonate-based resin composition according to any one of the above-mentioned items [1] to [9], wherein the R⁸ represents a dimethylene group, a methyl-substituted dimethylene group (—CH₂CHMe-), or a trimethylene group, and the “z” represents 1.
[11] The polycarbonate-based resin composition according to any one of the above-mentioned items [1] to [10], wherein a content of the polyorganosiloxane block (A-1) in the polycarbonate-polyorganosiloxane copolymer (A) is 0.1 mass % or more and 60 mass % or less.
[12] The polycarbonate-based resin composition according to any one of the above-mentioned items [1] to [11], wherein the polycarbonate-polyorganosiloxane copolymer (A) has a viscosity-average molecular weight (Mv) of 5,000 or more and 50,000 or less.
[13] The polycarbonate-based resin composition according to any one of the above-mentioned items [1] to [12], wherein a molded piece having a total length of 75 mm, a parallel-portion length of 30 mm, an end-portion width of 10 mm, a central parallel-portion width of 5 mm, and a thickness of 2 mm of a JIS K 7139:2009 dumbbell-shaped tensile test piece type A22, which is obtained by molding the polycarbonate-based resin composition, has a tensile modulus of elasticity of 2,400 MPa or more, which is measured under conditions of a tensile rate of 25 mm/min, a measurement temperature of 23° C., and a chuck-to-chuck distance of 57 mm.
[14] The polycarbonate-based resin composition according to any one of the above-mentioned items [1] to [13], wherein a molded piece having a total length of 75 mm, a parallel-portion length of 30 mm, an end-portion width of 10 mm, a central parallel-portion width of 5 mm, and a thickness of 2 mm of a JIS K 7139:2009 dumbbell-shaped tensile test piece type A22, which is obtained by molding the polycarbonate-based resin composition, has a tensile yield stress of 45 MPa or more, which is measured under conditions of a tensile rate of 25 mm/min, a measurement temperature of 23° C., and a chuck-to-chuck distance of 57 mm.
[15] The polycarbonate-based resin composition according to any one of the above-mentioned items [1] to [14], wherein a content of the release agent (B) is 0.001 part by mass or more and 2.0 parts by mass or less with respect to 100 parts by mass of the polycarbonate-based resin (S).
[16] The polycarbonate-based resin composition according to any one of the above-mentioned items [1] to [15], wherein the release agent (B) contains an ester of an aliphatic carboxylic acid and an alcohol.
[17] The polycarbonate-based resin composition according to any one of the above-mentioned items [1] to [16], wherein the release agent (B) contains at least one kind selected from the group consisting of: an ester of an aliphatic carboxylic acid and pentaerythritol; and an ester of an aliphatic carboxylic acid and glycerin.
[18] The polycarbonate-based resin composition according to any one of the above-mentioned items [1] to [17], wherein the polycarbonate-polyorganosiloxane copolymer (A) is a copolymer obtained by a melt polymerization method.
[19] The polycarbonate-based resin composition according to any one of the above-mentioned items [1] to [18], wherein the polycarbonate-polyorganosiloxane copolymer (A) is a copolymer obtained by using a diol monomer (a1).
[20] A molded body, comprising the polycarbonate-based resin composition of any one of the above-mentioned items [1] to [19].

### Advantageous Effects of Invention

According to the present invention, there can be provided the polycarbonate-based resin composition that can provide a molded body improved in balance between its mechanical strength and releasability, and the polycarbonate-based resin molded body improved in balance between its mechanical strength and releasability.

### DESCRIPTION OF EMBODIMENTS

A polycarbonate-based resin composition, and a molded body thereof, of the present invention are described in detail below. Herein, a specification considered to be preferred may be arbitrarily adopted, and a combination of preferred specifications can be said to be more preferred. The term “XX to YY” as used herein means “XX or more and YY or less.”

When a plurality of lower limit values such as ““x” or more” exist for one technical matter, or when a plurality of upper limit values such as ““y” or less” exist therefor, values arbitrarily selected from the upper limit values and the lower limit values may be combined.

### 1. Polycarbonate-Based Resin Composition

The polycarbonate-based resin composition of the present invention includes: a polycarbonate-based resin (S) containing a polycarbonate-polyorganosiloxane copolymer (A) having a polyorganosiloxane block (A-1) including a structural unit represented by the formula (1) and a polycarbonate block (A-2) including a structural unit represented by the formula (2); and a release agent (B).

The polycarbonate-based resin composition of the present invention can provide a molded body improved in balance between its mechanical strength and releasability.

The polycarbonate-based resin composition of the present invention can provide a molded body improved in balance between its mechanical strength and releasability.

### <Polycarbonate-Polyorganosiloxane Copolymer (A)>

The polycarbonate-polyorganosiloxane copolymer (A) has the polyorganosiloxane block (A-1) including the structural unit represented by the formula (1) and the polycarbonate block (A-2) including the structural unit represented by the formula (2):

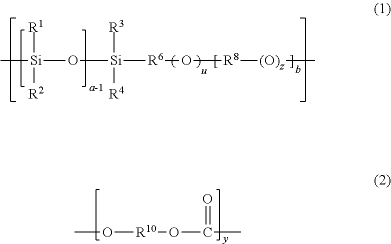

wherein R¹ to R⁴ each independently represent a hydrogen atom, a halogen atom, an alkyl group having 1 to 10 carbon atoms, an alkoxy group having 1 to 10 carbon atoms, an aryl group having 6 to 12 carbon atoms, or an alkylaryl group having 7 to 22 carbon atoms, R⁶ represents an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, a plurality of R⁸s may be identical to or different from each other, and each represent an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, R¹¹¹ represents an alkyl group having 1 to 10 carbon atoms, or an aryl group having 6 to 10 carbon atoms, “z” and “u” each represent 0 or 1, “a” represents an integer of from 2 to 500, “b” represents an integer of from 2 to 200, R¹⁰ represents a divalent aliphatic hydrocarbon group having 2 to 40 carbon atoms, a divalent alicyclic hydrocarbon group having 3 to 40 carbon atoms, or a divalent aromatic hydrocarbon group having 6 to 20 carbon atoms, and these groups may each be substituted with a substituent, and may each contain at least one atom selected from the group consisting of: an oxygen atom; a nitrogen atom; a sulfur atom; and a halogen atom, and “y” represents an integer of from 10 to 500.

The presence of the structural unit represented by the formula (1) can improve an affinity between the polycarbonate block (A-2) and the polyorganosiloxane structural moiety of the polyorganosiloxane block (A-1). It is assumed that as a result of the foregoing, separation between the components can be reduced, and hence a molded body improved in balance between its mechanical strength and releasability is obtained.

In addition, at the time of the production of the polycarbonate-polyorganosiloxane copolymer (A), when a monomer from which the polyorganosiloxane block (A-1) is derived includes the structural unit represented by the formula (1), the compatibility of the monomer with any other raw material component is improved. The inventors of the present invention have assumed that as a result of the foregoing, the reaction ratio of the monomer is improved, and hence a polyorganosiloxane structure can be incorporated into the polycarbonate-polyorganosiloxane copolymer (A) with high randomness. It is assumed that a molded body improved in balance between its mechanical strength and releasability is obtained because the presence of the structural unit represented by the formula (1) can reduce the amounts of an unreacted polyorganosiloxane that has been incapable of copolymerization and the copolymer having incorporated thereinto an excessive amount of the polyorganosiloxane, and as a result, the separation between the components caused by these components can be reduced.

The polyorganosiloxane block (A-1) serving as one constituent unit of the polycarbonate-polyorganosiloxane copolymer (A) includes the structural unit represented by the formula (1).

The polyorganosiloxane block (A-1) is a structural unit present between two polycarbonate bonds closest to each other on the main chain of the polycarbonate-polyorganosiloxane copolymer (A), and includes at least one repeating unit represented by the following formula (X):

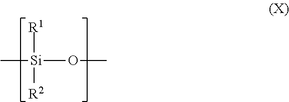

wherein R¹ and R² each represent the same meaning as that described above.

The polyorganosiloxane block (A-1) including the structural unit represented by the formula (1) preferably includes at least one selected from the group consisting of structural units represented by the formulae (1-1) to (1-3), and more preferably includes the structural unit represented by the formula (1-1):

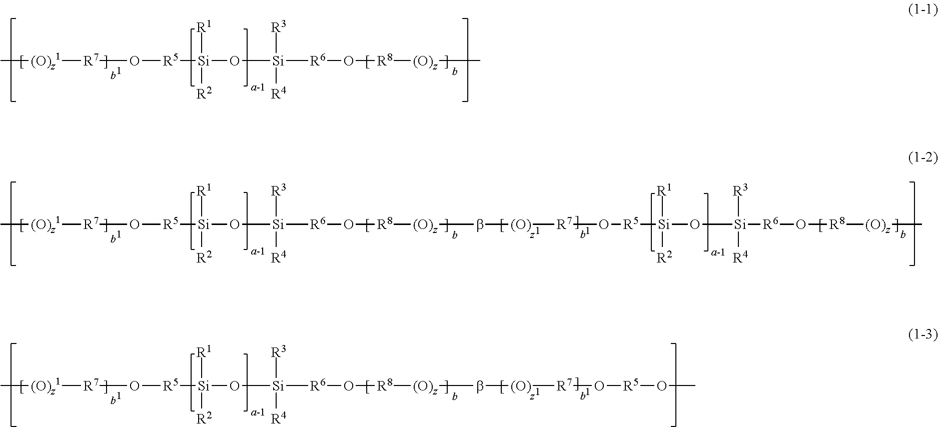

wherein R¹ to R⁴, R⁶, R⁸, “z”, “a”, and “b” each represent the same meaning as that described above, R⁵ represents an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, R⁷ represents an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, R¹¹¹ represents an alkyl group having 1 to 10 carbon atoms, or an aryl group having 6 to 10 carbon atoms, z¹ represents 0 or 1, b1 represents an integer of from 2 to 200, and B represents a divalent group derived from a diisocyanate compound, or a divalent group derived from a dicarboxylic acid or a dicarboxylic acid halide.

Examples of the halogen atom represented by any one of R¹ to R⁴ in the formulae include a fluorine atom, a chlorine atom, a bromine atom, and an iodine atom. Examples of the alkyl group having 1 to 10 carbon atoms that is represented by any one of R¹ to R⁴ include a methyl group, an ethyl group, a n-propyl group, an isopropyl group, various butyl groups, various pentyl groups, and various hexyl groups (the term “various” as used herein means that a linear group and all kinds of branched groups are included, and the same holds true for the following). The alkoxy group having 1 to 10 carbon atoms that is represented by any one of R¹ to R⁴ is, for example, an alkoxy group whose alkyl group moiety is the same as the alkyl group. Examples of the aryl group having 6 to 12 carbon atoms that is represented by any one of R¹ to R⁴ include a phenyl group and a naphthyl group. The alkylaryl group having 7 to 22 carbon atoms that is represented by any one of R¹ to R⁴ is, for example, an alkylaryl group whose alkyl group moiety is the same as the alkyl group and whose aryl group moiety is the same as the aryl group.

R¹ to R⁴ each preferably represent a hydrogen atom, an alkyl group having 1 to 6 carbon atoms, an alkoxy group having 1 to 6 carbon atoms, an aryl group having 6 to 12 carbon atoms, or an arylalkyl group having 7 to 22 carbon atoms, each more preferably represent an alkyl group having 1 to 6 carbon atoms, and each still more preferably represent a methyl group.

Examples of the arylene group having 6 to 20 carbon atoms that is represented by R⁵, R⁶, R⁷, or R⁸ include a phenylene group and a naphthylene group. Examples of the alkylene group having 1 to 10 carbon atoms that is represented by R⁵, R⁶, R⁷, or R⁸ include a methylene group, a dimethylene group, a trimethylene group, a methyl-substituted dimethylene group, and various butylene groups. Among the various butylene groups, a tetramethylene group is preferred. The alkylarylene group that is represented by R⁵, R⁶, R⁷, or R⁸ is, for example, an alkylarylene group whose alkyl group moiety is the same as the alkylene group and whose arylene group moiety is the same as the arylene group. However, those groups may each contain, in at least one of a main chain or a side chain thereof, at least one group selected from the group consisting of: —O—; —COO— (the group may be any one of —C(═O)O— and —OC(═O)—); —CO—; —S—; —NH—; and —NR¹¹¹—. R¹¹¹ represents an alkyl group having 1 to 10 carbon atoms, or an aryl group having 6 to 10 carbon atoms. Examples of the alkyl group having 1 to 10 carbon atoms that is represented by R¹¹¹ include a methyl group, an ethyl group, a n-propyl group, an isopropyl group, various butyl groups, various pentyl groups, and various hexyl groups. Examples of the aryl group having 6 to 10 carbon atoms that is represented by R¹¹¹ include a phenyl group and a naphthyl group.

R⁵, R⁶, R⁷, and R⁸ each represent preferably an alkylene group having 1 to 10 carbon atoms, more preferably an alkylene group having 1 to 5 carbon atoms, still more preferably a dimethylene group, a methyl-substituted dimethylene group (—CH₂CHMe- or —CHMeCH₂—), or a trimethylene group. R⁵ and R⁶ each still more preferably represent a trimethylene group. R⁷ and R⁸ each still more preferably represent a dimethylene group.

In this description, the symbol “-Me” represents a methyl group (—CH₃ group).

It is preferred that “z” and z¹ each represent 1, and it is more preferred that both of “z” and z¹ represent 1.

When any one of R¹ to R⁸, “z”, z¹, “a”, “b”, and b1 is present in plurality, the plurality of symbols may be identical to or different from each other.

In the formula (1), it is still more preferred that R¹ to R⁴ each represent a methyl group, R⁶ represent a trimethylene group, R⁸ represent a dimethylene group, and “z” represent 1, and it is still more preferred that R¹ to R⁴ each represent a methyl group, R⁶ represent a trimethylene group, R⁸ represent a dimethylene group, “z” represent 1, and “u” represent 1.

In the formulae (1-1) to (1-3), it is still more preferred that R¹ to R⁴ each represent a methyl group, R⁵ and R⁶ each represent a trimethylene group, R⁷ and R⁸ each represent a dimethylene group, and “z” and z¹ each represent 1.

Examples of the divalent group derived from a diisocyanate compound, or the divalent group derived from a dicarboxylic acid or a dicarboxylic acid halide, which is represented by 8, include divalent groups represented by the following formulae (iii) to (vii).

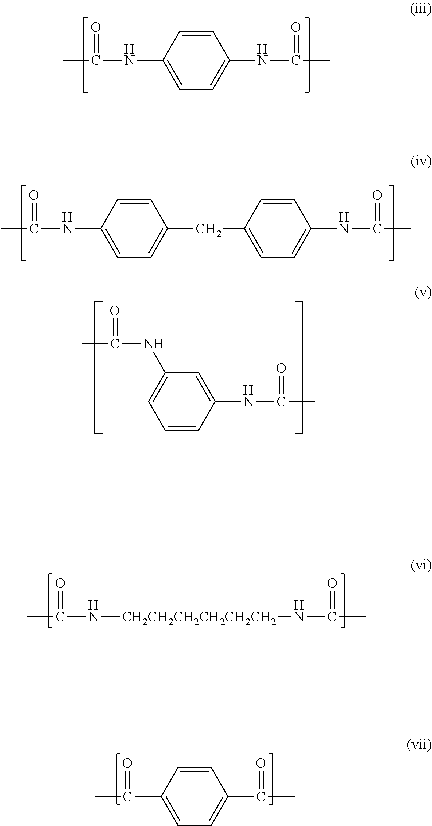

“a” represents the number of the repeating units of the polyorganosiloxane, and represents an integer of preferably 2 or more, more preferably 10 or more, still more preferably 15 or more, still more preferably 20 or more, still more preferably 35 or more, and preferably 500 or less, more preferably 300 or less, still more preferably 100 or less, still more preferably 70 or less, still more preferably 65 or less, still more preferably 50 or less.

The average number of the repeating units of the polyorganosiloxane that is the average of “a” is preferably 2 or more, more preferably 10 or more, still more preferably 15 or more, still more preferably 20 or more, still more preferably 35 or more, and is preferably 500 or less, more preferably 300 or less, still more preferably 100 or less, still more preferably 70 or less, still more preferably 65 or less, still more preferably 50 or less. The average number of the repeating units of the polyorganosiloxane preferably falls within the above-mentioned ranges because the polycarbonate-polyorganosiloxane copolymer has a higher total light transmittance, and hence serves as a highly transparent copolymer.

“b” and b1 each represent the number of the repeating units of a terminal modified group of the polyorganosiloxane, and each independently represent an integer of preferably 2 or more, more preferably 5 or more, still more preferably 8 or more, still more preferably 10 or more, still more preferably 12 or more, and preferably 200 or less, more preferably 100 or less, still more preferably 50 or less, still more preferably 45 or less, still more preferably 40 or less, still more preferably 38 or less.

The average number of the repeating units of the terminal modified group of the polyorganosiloxane that is the average of each of “b” and b1 is preferably 2 or more, more preferably 5 or more, still more preferably 8 or more, still more preferably 10 or more, still more preferably 12 or more, and is preferably 200 or less, more preferably 100 or less, still more preferably 50 or less, still more preferably 45 or less, still more preferably 40 or less, still more preferably 38 or less. The average number preferably falls within the above-mentioned ranges because a raw material is easily available. The average number of the repeating units of the terminal modified group of the polyorganosiloxane is more preferably 10 or more because the balance between the mechanical strength and releasability of the molded body to be obtained can be further improved. The average number of the repeating units of the terminal modified group of the polyorganosiloxane is more preferably 100 or less because a reduction in handleability of the polyorganosiloxane due to increases in viscosity and melting point thereof can be suppressed. The average number of the repeating units of the terminal modified group of the polyorganosiloxane is more preferably 50 or less because the content of the polyorganosiloxane block in the resin can be kept at such an amount that a physical property-improving effect can be maintained.

In the formula (1) or the formulae (1-1) to (1-3), “z” and z¹ each independently represent 0 or 1, preferably 1.

In the formula (1), “u” represents 0 or 1, preferably 1.

Examples of the divalent aliphatic hydrocarbon group having 2 to 40 carbon atoms that is represented by R¹⁰ in the formula (2) include an ethylene group, a n-propylene group, an isopropylene group, a n-butylene group, an isobutylene group, a n-pentylene group, a n-hexylene group, a n-heptylene group, a noctylene group, a 2-ethylhexylene group, a n-nonylene group, a n-decylene group, a n-undecylene group, a n-dodecylene group, a n-tridecylene group, a n-tetradecylene group, a n-pentadecylene group, a n-hexadecylene group, a n-heptadecylene group, and a noctadecylene group. However, those groups may each be substituted with a substituent, and may each contain at least one atom selected from the group consisting of: an oxygen atom; a nitrogen atom; a sulfur atom; and a halogen atom.

Examples of the divalent alicyclic hydrocarbon group having 3 to 40 carbon atoms that is represented by R¹⁰ in the formula (2) include a cyclopentylene group, a cyclohexylene group, a cyclooctylene group, a cyclodecylene group, a cyclotetradecylene group, an adamantylene group, a bicycloheptylene group, a bicyclodecylene group, and a tricyclodecylene group. However, those groups may each be substituted with a substituent, and may each contain at least one atom selected from the group consisting of: an oxygen atom; a nitrogen atom; a sulfur atom; and a halogen atom.

Examples of the divalent aromatic hydrocarbon group having 6 to 20 carbon atoms that is represented by R¹⁰ in the formula (2) may include divalent aromatic hydrocarbon groups derived from 2,2-bis(4-hydroxyphenyl)propane (also referred to as “bisphenol A”), 2,2-bis(4-hydroxy-3-methylphenyl)propane (also referred to as “bisphenol C”), 1,1-bis(4-hydroxyphenyl)cyclohexane (also referred to as “bisphenol Z”), 1,1-bis(4-hydroxyphenyl)-3-methylcyclohexane (also referred to as “bisphenol 3MZ”), 1,1-bis(4-hydroxyphenyl)-3,3,5-trimethylcyclohexane (also referred to as “bisphenol HTG”), 1,1-bis(4-hydroxyphenyl)cyclododecene, hydroquinone, resorcinol (also referred to as “resorcin”), and catechol. Such divalent aromatic hydrocarbon groups are derived by, for example, using the above-mentioned compounds at the time of the production of the copolymer. However, those groups may each be substituted with a substituent, and may each contain at least one atom selected from the group consisting of: an oxygen atom; a nitrogen atom; a sulfur atom; and a halogen atom.

The polycarbonate block (A-2) including the structural unit represented by the formula (2) preferably includes at least one of a structural unit represented by the formula (111) or a structural unit represented by the formula (112), and more preferably includes the structural unit represented by the formula (111).

In a preferred aspect of the present invention, the polycarbonate block (A-2) includes preferably 90 mol % or more, more preferably 95 mol % or more, still more preferably 98 mol % or more, still more preferably 99 mol % or more, still more preferably 100 mol % or more of the structural unit represented by the formula (111) in 100 mol % of the structural unit represented by the formula (2).

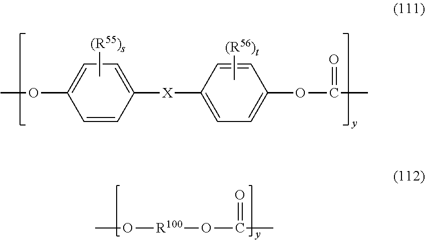

wherein R⁵⁵ and R⁵⁶ each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, an arylene group having 6 to 20 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R¹⁰⁰ represents a divalent aliphatic hydrocarbon group having 2 to 40 carbon atoms, and the divalent aliphatic hydrocarbon group may include at least one selected from the group consisting of: a branched structure; and a cyclic structure, and may contain at least one atom selected from the group consisting of: an oxygen atom; a nitrogen atom; a sulfur atom; and a halogen atom, “y” represents an integer of from 10 to 500, and “s” and “t” each independently represent an integer of from 0 to 4.

Examples of the halogen atom that is represented by R⁵⁵ or R⁵⁶ include a fluorine atom, a chlorine atom, a bromine atom, and an iodine atom.

Examples of the alkyl group having 1 to 6 carbon atoms that is represented by R⁵⁵ or R⁵⁶ include a methyl group, an ethyl group, a n-propyl group, an isopropyl group, various butyl groups, various pentyl groups, and various hexyl groups. The alkoxy group that is represented by R⁵⁵ or R⁵⁶ is, for example, an alkoxy group whose alkyl group moiety is the same as the alkyl group.

Examples of the alkylene group having 1 to 8 carbon atoms that is represented by X include a methylene group, an ethylene group, a trimethylene group, a tetramethylene group, and a hexamethylene group. Among them, an alkylene group having 1 to 5 carbon atoms is preferred. Examples of the alkylidene group having 2 to 8 carbon atoms that is represented by X include an ethylidene group and an isopropylidene group. Examples of the cycloalkylene group having 5 to 15 carbon atoms that is represented by X include a cyclopentanediyl group, a cyclohexanediyl group, and a cyclooctanediyl group. Among them, a cycloalkylene group having 5 to 10 carbon atoms is preferred. Examples of the arylene group having 6 to 20 carbon atoms that is represented by X include a phenylene group, a naphthylene group, and a biphenylene group. Examples of the cycloalkylidene group having 5 to 15 carbon atoms that is represented by X include a cyclohexylidene group, a 3,5,5-trimethylcyclohexylidene group, and a 2-adamantylidene group. Among them, a cycloalkylidene group having 5 to 10 carbon atoms is preferred, and a cycloalkylidene group having 5 to 8 carbon atoms is more preferred. The arylalkylene group having 7 to 15 carbon atoms that is represented by X is, for example, an arylalkylene group whose aryl moiety is an aryl group having 6 to 14 ring-forming carbon atoms, such as a phenyl group, a naphthyl group, a biphenyl group, or an anthryl group, and whose alkylene moiety is the same as the alkylene. The arylalkylidene group having 7 to 15 carbon atoms that is represented by X is, for example, an arylalkylidene group whose aryl moiety is an aryl group having 6 to 14 ring-forming carbon atoms, such as a phenyl group, a naphthyl group, a biphenyl group, or an anthryl group, and whose alkylidene moiety is the same as the alkylidene.

“s” and “t” each independently represent an integer of from 0 to 4, preferably from 0 to 2, more preferably 0 or 1. Among them, it is preferred that “s” and “t” each represent 0, and X represent a single bond or an alkylene group having 1 to 8 carbon atoms, it is also preferred that “s” and “t” each represent 0, and X represent an alkylidene group, and it is particularly suitable that “s” and “t” each represent 0, and X represent an isopropylidene group.

Examples of the divalent aliphatic hydrocarbon group having 2 to 40 carbon atoms that is represented by R¹⁰⁰ include an alkylene group having 2 to 40 carbon atoms, a cycloalkylene group having 4 to 40 carbon atoms, and an oxygen- or nitrogen-containing divalent saturated heterocyclic group having 4 to 40 carbon atoms. The number of the carbon atoms of the alkylene group is preferably from 2 to 18, more preferably from 2 to 10, still more preferably from 3 to 6. The number of the carbon atoms of the cycloalkylene group is preferably from 4 to 20, more preferably from 5 to 20. The number of the carbon atoms of the oxygen- or nitrogen-containing divalent saturated heterocyclic group is preferably from 4 to 20, more preferably from 5 to 20. However, those groups may each include at least one selected from the group consisting of: a branched structure; and a cyclic structure, and may each contain at least one atom selected from the group consisting of: an oxygen atom; a nitrogen atom; a sulfur atom; and a halogen atom.

Examples of the alkylene group having 2 to 40 carbon atoms include an ethylene group, a n-propylene group, an isopropylene group, a n-butylene group, an isobutylene group, a n-pentylene group, a n-hexylene group, a n-heptylene group, a n-octylene group, a 2-ethylhexylene group, a n-nonylene group, a n-decylene group, a n-undecylene group, a n-dodecylene group, a n-tridecylene group, a n-tetradecylene group, a n-pentadecylene group, a n-hexadecylene group, a n-heptadecylene group, and a n-octadecylene group. Examples of the cycloalkylene group having 4 to 40 carbon atoms include a cyclopentylene group, a cyclohexylene group, a cyclooctylene group, a cyclodecylene group, a cyclotetradecylene group, an adamantylene group, a bicycloheptylene group, a bicyclodecylene group, and a tricyclodecylene group. The oxygen- or nitrogen-containing divalent heterocyclic group having 4 to 40 carbon atoms may be, for example, a group containing an oxygen or nitrogen atom in the skeleton of the cycloalkylene group.

Specifically, the polycarbonate block (A-2) formed of the repeating unit represented by the formula (2) preferably includes at least one selected from the group consisting of structural units represented by the following formulae (a-i) to (a-xiii), more preferably includes at least one selected from the group consisting of the structural units represented by the following formulae (a-i) to (a-v), still more preferably includes at least one selected from the group consisting of the structural units represented by the following formulae (a-i), (a-ii), and (a-v), and still more preferably includes the structural unit represented by the following formula (a-v). The incorporation of such preferred structural unit provides higher transparency.

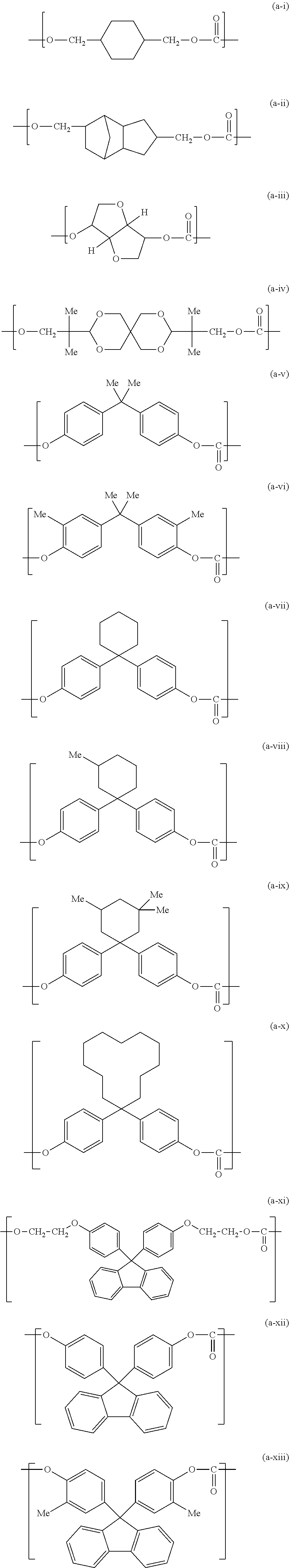

The polycarbonate block (A-2) represented by the formula (2) preferably includes a structural unit derived from at least one compound selected from the group consisting of: 2,2-bis(4-hydroxyphenyl)propane; 2,2-bis(4-hydroxy-3-methylphenyl)propane; 1,1-bis(4-hydroxyphenyl)cyclohexane; 1,1-bis(4-hydroxyphenyl)-3-methylcyclohexane; 1,1-bis(4-hydroxyphenyl)-3,3,5-trimethylcyclohexane; 1,1-bis(4-hydroxyphenyl)cyclododecene; isosorbide; cyclohexane-1,4-dimethanol; tricyclodecane dimethanol; 3,9-bis(1,1-dimethyl-2-hydroxyethyl)-2,4,8, 10-tetraoxaspiro[5.5]undecane; 1,3-propanediol; and 1,4-butanediol. Such structural unit may be derived by, for example, using the compound at the time of the production of the copolymer.

“y” represents more preferably 20 or more, still more preferably 40 or more, and more preferably 200 or less, still more preferably 100 or less. “y” preferably represents 20 or more because an increase in amount of a low-molecular weight component in the copolymer can be suppressed. “y” more preferably represents 40 or more because the toughness of the copolymer is improved. “y” preferably represents 200 or less because moderate fluidity is obtained at the time of the molding of the copolymer. “y” more preferably represents 100 or less because a reaction mixture at the time of the production of the copolymer has moderate fluidity, and hence productivity is improved.

The polyorganosiloxane block (A-1) preferably includes the structural unit represented by the formula (1) as a main component. The term “main component” as used herein means that its content with respect to all structures is 50 mass % or more. The content of the structural unit represented by the formula (1) in the polyorganosiloxane block (A-1) is preferably 50 mass % or more, more preferably 80 mass % or more, still more preferably 90 mass % or more, still more preferably 98 mass % or more with respect to all the structures of the polyorganosiloxane block (A-1).

The polycarbonate block (A-2) preferably includes the structural unit represented by the formula (2) as a main component. The content of the structural unit represented by the formula (2) in the polycarbonate block (A-2) is preferably 50 mass % or more, more preferably 80 mass % or more, still more preferably 90 mass % or more, still more preferably 98 mass % or more with respect to all the structures of the polyorganosiloxane block (A-1).

The content of the polyorganosiloxane block (A-1) in the polycarbonate-polyorganosiloxane copolymer (A) is preferably 0.1 mass % or more, more preferably 0.5 mass % or more, still more preferably 1.0 mass % or more, still more preferably 3.0 mass % or more, and is preferably 60 mass % or less, more preferably 40 mass % or less, still more preferably 20 mass % or less, still more preferably 10 mass % or less.

When the content of the polyorganosiloxane block in the polycarbonate-polyorganosiloxane copolymer (A) falls within the above-mentioned ranges, more excellent impact resistance and more excellent transparency can be obtained.

The content of the polycarbonate block (A-2) in the polycarbonate-polyorganosiloxane copolymer (A) is preferably 40 mass % or more, more preferably 60 mass % or more, still more preferably 80 mass % or more, still more preferably 90 mass % or more, and is preferably 99.9 mass % or less, more preferably 99.5 mass % or less, still more preferably 99.0 mass % or less, still more preferably 97.0 mass % or less.

The expression “content of the polyorganosiloxane block (A-1) in the polycarbonate-polyorganosiloxane copolymer (A)” as used herein refers to the percentage of the total mass of the structural unit represented by the formula (X) with respect to the total mass of the polycarbonate block (A-2), the structural unit represented by the formula (X), a structural unit represented by the following formula (Y), and a terminal structure derived from a terminal stopper to be described later that the polycarbonate-polyorganosiloxane copolymer (A) contains as required. The same holds true for the “content of the polyorganosiloxane block (A-1) in the polycarbonate-based resin (S)” and the “content of the polyorganosiloxane block (A-1) in the polycarbonate-based resin composition” to be described later.

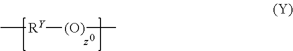

wherein R^{Y} represents R⁷ or R⁸, when R^{Y} represents R⁸, z⁰ represents “z”, and when R^{Y} represents R⁷, z⁰ represents z¹, and R⁷, R⁸, “z”, and z¹ each represent the same meaning as that described above.

In this description, the terms “content” and “content ratio” may be used in an exchangeable manner.

The viscosity-average molecular weight of the polycarbonate-polyorganosiloxane copolymer (A) is preferably 5,000 or more, more preferably 12,000 or more, still more preferably 14,000 or more, still more preferably 16,000 or more, and is preferably 50,000 or less, more preferably 30,000 or less, still more preferably 23,000 or less, still more preferably 21,000 or less.

The viscosity-average molecular weight (Mv) herein is a value calculated from the following Schnell's equation by measuring the limiting viscosity [n] of a methylene chloride solution (concentration: g/L) at 20° C.

[η]=1.23×10⁻⁵Mv^{0.83}

The polycarbonate-polyorganosiloxane copolymer (A) may be produced by, for example, using a diol monomer (a1) and a polyorganosiloxane (a2) as raw material monomers.

«Diol Monomer (a1)»

The diol monomer (a1) is not particularly limited as long as the monomer has a structure represented by the following formula (a1). An aromatic dihydroxy compound or an aliphatic dihydroxy compound may be used as the diol monomer (a1).

HO—R¹⁰—OH (a1)

In the formula (a1), R¹⁰ is as described above, and preferred examples thereof are also the same as those described above.

«Polyorganosiloxane (a2)»

The polyorganosiloxane (a2) preferably has a structure represented by the following formula (a2-0):

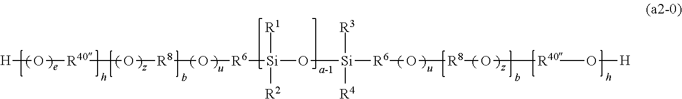

wherein R¹ to R¹, R⁶, R⁸, “z”, “a”, “b”, and “u” each represent the same meaning as that described above, provided that a plurality of R¹s, a plurality of R²s, a plurality of R⁶s, or a plurality of R⁸s may be identical to or different from each other, R⁴⁰″ represents a hydrocarbon group having 1 to 40 carbon atoms that may have, in at least one of a main chain or a side chain thereof, a structure containing one or more heteroatoms, and “e” and “h” each represent 0 or 1.

The hydrocarbon group represented by R⁴⁰″ preferably includes a repeating chain structure in which at least two of at least one hydrocarbon group selected from the group consisting of: a divalent aliphatic hydrocarbon group having 1 to 20 carbon atoms; a divalent alicyclic hydrocarbon group having 3 to 20 carbon atoms; and a divalent aromatic hydrocarbon group having 6 to 20 carbon atoms, and a divalent structure containing at least one heteroatom selected from the group consisting of: an oxygen atom; a nitrogen atom; and a sulfur atom are linked to each other.

Examples of the divalent aliphatic hydrocarbon group having 1 to 20 carbon atoms include a methylene group and the same groups as those given as the examples of the divalent aliphatic hydrocarbon group having 2 to 40 carbon atoms that is represented by R^{10.}

Examples of the divalent alicyclic hydrocarbon group having 3 to 20 carbon atoms include the same groups as those given as the examples of the divalent alicyclic hydrocarbon group having 3 to 40 carbon atoms that is represented by R¹⁰.

Examples of the divalent aromatic hydrocarbon group having 6 to 20 carbon atoms include the same groups as those given as the examples of the divalent aromatic hydrocarbon group having 6 to 20 carbon atoms that is represented by R^{10.}

Examples of the divalent structure containing at least one heteroatom selected from the group consisting of: an oxygen atom; a nitrogen atom; and a sulfur atom include —O—, —(C═O)—, —O(C═O)— (the divalent structure may be any one of —O(C═O)— and —(C═O)O—), —O(C═O)O—, —NR—, —NR—(C═O)— (the divalent structure may be any one of —NR—(C═O)— and —(C═O)—NR—), —N═CR— (the divalent structure may be any one of —N═CR— and —CR═N—), —SH, —S—, —S-S—, and —(S═O)—. The R represents a hydrogen atom, a monovalent aliphatic hydrocarbon group having 1 to 20 carbon atoms, or a monovalent aromatic hydrocarbon group having 6 to 20 carbon atoms, and these groups may each be substituted with a substituent.

The repeating chain structure preferably includes at least one structure selected from the group consisting of: a polyether; a polyacetal; a polylactone; a polyacrylate; a polyester; a polycarbonate; a polyketone; a polysulfide; a polysulfone; a polyamide; and a polyimide. Among them, at least one structure selected from the group consisting of: a polyether; a polyacrylate; and a polycarbonate is preferably incorporated into the repeating chain structure, and a polyether is most preferably incorporated thereinto. The polyether is preferably a polyalkylene ether. Among them, a polyethylene glycol, a polypropylene glycol, a polytrimethylene glycol, and a polytetramethylene glycol are preferred. The above-mentioned structures are preferred from the viewpoint of further improving the affinity of the polyorganosiloxane (a2) for the diol monomer (a1) to perform more uniform polymerization.

In addition, the repeating chain structure may have at least one substituent selected from the group consisting of: —OH; —NH₂; and —NRH. R represents the same meaning as that described above.

The polyorganosiloxane (a2) is preferably a monomer having any one of structures represented by the following formulae (a2-1) to (a2-3):

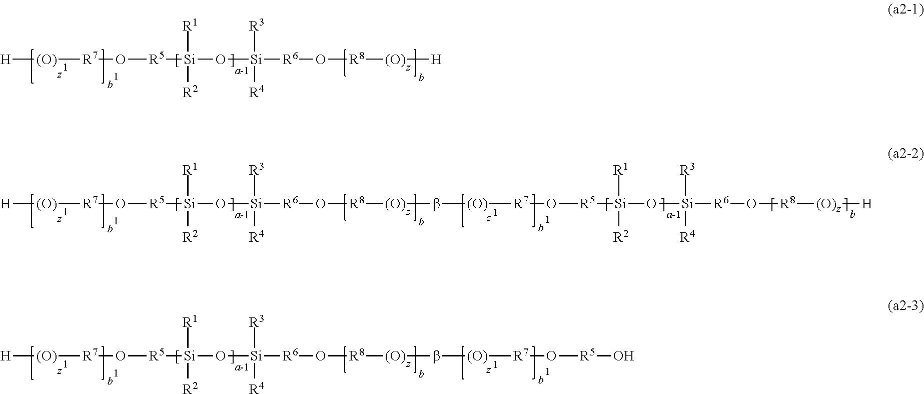

wherein R¹ to R¹, R⁵, R⁶, R⁷, R⁸, “z”, z¹, β, “a”, “b”, and b¹ each represent the same meaning as that described above, and preferred examples thereof are also the same as those described above, and a combination of preferred examples is similarly preferred.

A method of producing the polyorganosiloxane (a2) is not particularly limited. According to, for example, a method described in JP 11-217390 A, the polyorganosiloxane may be obtained by: causing a cyclotrisiloxane and a disiloxane to react with each other in the presence of an acidic catalyst to synthesize an α,ω-dihydrogen organopentasiloxane; and then subjecting the α,ω-dihydrogen organopentasiloxane to an addition reaction with an oligomer or a polymer (e.g., a polyalkylene ether, a polyester, or a polycarbonate) having one terminal modified with an allyl group in the presence of a catalyst for a hydrosilylation reaction. In addition, according to a method described in JP 2662310 B2, the polyorganosiloxane may be obtained by: causing octamethylcyclotetrasiloxane and tetramethyldisiloxane to react with each other in the presence of an acidic catalyst such as sulfuric acid; and subjecting the resultant α,ω-dihydrogen organopolysiloxane to an addition reaction with the oligomer or the polymer having one terminal modified with an allyl group in the presence of the catalyst for a hydrosilylation reaction in the same manner as that described above. The α,ω-dihydrogen organopolysiloxane may be used after its average number “a” of repetitions has been appropriately adjusted by its polymerization conditions, or a commercially available α,ω-dihydrogen organopolysiloxane may be used. In addition, the oligomer having one terminal modified with an allyl group may be used after its average number “b” of repetitions has been appropriately adjusted by its polymerization conditions, or a commercially available one-terminal allyl group-modified oligomer may be used. Among the one-terminal allyl group-modified oligomers, a one-terminal allyl group-modified polyethylene glycol may be produced with reference to, for example, JP 5652691 B2. In addition, a commercially available allyl group-modified polyethylene glycol is, for example, UNIOX PKA-5001, UNIOX PKA-5002, UNIOX PKA-5003, UNIOX PKA-5004, or UNIOX PKA-5005 manufactured by NOF Corporation.

The polycarbonate-polyorganosiloxane copolymer (A) may be produced through the polymerization of raw material monomers by an interfacial polymerization method or a melt polymerization method (ester exchange method). When the copolymer is produced by the interfacial polymerization method, for example, a method described in JP 2014-80462 A may be adopted. The polycarbonate-polyorganosiloxane copolymer (A) may be produced by causing the polyorganosiloxane (a2), the diol monomer (a1), and a carbonic acid ester compound, which are the raw material monomers, to react with each other by the melt polymerization method preferably in the presence of a basic catalyst. At this time, the polymerization reaction may be performed by further adding a terminal stopper.

The melt polymerization method is environmentally and economically advantageous because the method does not require a solvent such as methylene chloride required in the interfacial polymerization method. In addition, the melt polymerization method is advantageous in terms of production because the method does not involve the use of phosgene having high toxicity to be used as a carbonate source in the interfacial polymerization method.

### (Carbonic Acid Ester Compound)

Examples of the carbonic acid ester compound may include a diaryl carbonate compound, a dialkyl carbonate compound, and an alkyl aryl carbonate compound.

Examples of the diaryl carbonate compound include a compound represented by the following formula (11) and a compound represented by the following formula (12):

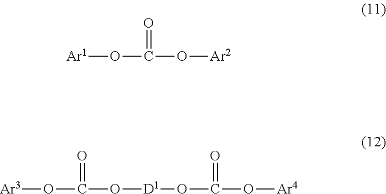

wherein in the formula (11), Ar¹ and Ar² each represent an aryl group, and the groups may be identical to or different from each other, and in the formula (12), Ar³ and Ar⁴ each represent an aryl group, and the groups may be identical to or different from each other, and D¹ represents a residue obtained by removing two hydroxy groups from the aromatic dihydroxy compound or the aliphatic dihydroxy compound.

Examples of the dialkyl carbonate compound include a compound represented by the following formula (13) and a compound represented by the following formula (14):

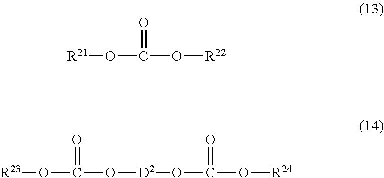

wherein in the formula (13), R²¹ and R²² each represent an alkyl group having 1 to 20 carbon atoms, or a cycloalkyl group having 4 to 20 carbon atoms, and the groups may be identical to or different from each other, and in the formula (14), R²³ and R²⁴ each represent an alkyl group having 1 to 20 carbon atoms, or a cycloalkyl group having 4 to 20 carbon atoms, and the groups may be identical to or different from each other, and D² represents a residue obtained by removing two hydroxy groups from the aromatic dihydroxy compound or the aliphatic dihydroxy compound.

Examples of the alkyl aryl carbonate compound include a compound represented by the following formula (15) and a compound represented by the following formula (16):

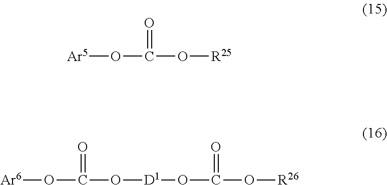

wherein in the formula (15), Ar⁵ represents an aryl group, and R²⁵ represents an alkyl group having 1 to 20 carbon atoms, or a cycloalkyl group having 4 to 20 carbon atoms, and in the formula (16), Ar⁶ represents an aryl group, R²⁶ represents an alkyl group having 1 to 20 carbon atoms, or a cycloalkyl group having 4 to 20 carbon atoms, and DI represents a residue obtained by removing two hydroxy groups from the aromatic dihydroxy compound or the aliphatic dihydroxy compound.

Examples of the diaryl carbonate compound include diphenyl carbonate, ditolyl carbonate, bis(chlorophenyl) carbonate, bis(m-cresyl) carbonate, dinaphthyl carbonate, bis(diphenyl) carbonate, and bisphenol A bisphenyl carbonate.

Examples of the dialkyl carbonate compound include diethyl carbonate, dimethyl carbonate, dibutyl carbonate, dicyclohexyl carbonate, and bisphenol A bismethyl carbonate.

Examples of the alkyl aryl carbonate compound include methyl phenyl carbonate, ethyl phenyl carbonate, butyl phenyl carbonate, cyclohexyl phenyl carbonate, and bisphenol A methyl phenyl carbonate.

A preferred carbonic acid ester compound is diphenyl carbonate.

One or two or more kinds of carbonic acid ester compounds may be used in the production of the polycarbonate-polyorganosiloxane copolymer (A).

### (Terminal Stopper)

In the production of the polycarbonate-polyorganosiloxane copolymer (A), a terminal stopper may be used as required. Any known terminal stopper in the production of a polycarbonate resin may be used as the terminal stopper. Specific examples thereof may include the following compounds: phenol, p-cresol, p-tert-butylphenol, p-tertoctylphenol, p-cumylphenol, p-nonylphenol, and p-tert-amylphenol. Those monohydric phenols may be used alone or in combination thereof.

### (Branching Agent)

In the production of the polycarbonate-polyorganosiloxane copolymer (A), a branching agent may be used. Examples of the branching agent include phloroglucin, trimellitic acid, 1,1,1-tris(4-hydroxyphenyl)ethane, 1-[α-methyl-α-(4′-hydroxyphenyl)ethyl]-4-[α′,α′-bis(4″-hydroxyphenyl)ethyl]benzene, α,α′,α″-tris(4-hydroxyphenyl)-1,3,5-triisopropylbenzene, and isatinbis(o-cresol).

Specifically, the polycarbonate-polyorganosiloxane copolymer (A) may be produced by the melt polymerization method in accordance with, for example, the following procedure.

The diol monomer (a1), the polyorganosiloxane (a2), and the carbonic acid ester compound are subjected to an ester exchange reaction. The molar amount of the carbonic acid ester compound is preferably from 0.9 times to 1.2 times, more preferably from 0.98 times to 1.02 times as large as that of the diol monomer.

At the time of the ester exchange reaction, the terminal stopper is preferably present in an amount within the range of from 0.05 mol % to 10 mol % with respect to the total amount of the diol monomer (a1) and the polyorganosiloxane (a2) from the viewpoint that the hydroxy group terminal of the polycarbonate-polyorganosiloxane copolymer to be obtained is sufficiently sealed, and hence a polycarbonate resin excellent in heat resistance and water resistance is obtained. The terminal stopper is more preferably present in an amount of from 1 mol % to 6 mol % with respect to the total amount of the diol monomer (a1) and the polyorganosiloxane (a2). The total amount of the terminal stopper may be added to a reaction system in advance, or the following may be adopted: part of the terminal stopper is added to the reaction system in advance, and the remainder thereof is added thereto along with the progress of the reaction.

The ester exchange reaction is preferably performed in the presence of an antioxidant by simultaneously loading the antioxidant into a reactor together with the diol monomer (a1), the polyorganosiloxane (a2), and the carbonic acid ester compound.

When the ester exchange reaction is performed, a reaction temperature is not particularly limited, and the temperature may fall within, for example, the range of from 100° C. to 330° C., and falls within preferably the range of from 180° C. to 300° C., more preferably the range of from 200° C. to 240° C. In addition, a method including gradually increasing the temperature to from 180° C. to 300° C. in accordance with the progress of the reaction is preferred. When the temperature of the ester exchange reaction is 100° C. or more, a reaction rate sufficiently increases. Meanwhile, when the temperature is 330° C. or less, the occurrence of a side reaction reduces and a problem such as the coloring of the polycarbonate-polyorganosiloxane copolymer to be produced hardly occurs.

A reaction pressure is set depending on the vapor pressure of a monomer to be used and/or the reaction temperature. The pressure is not particularly limited as long as the pressure is set so that the reaction may be efficiently performed. For example, the following is adopted: at the initial stage of the reaction, it is preferred that the pressure be set to an atmospheric pressure (normal pressure) or pressurized state ranging from 1 atm to 50 atm (760 torr to 38,000 torr), and at the later stage of the reaction, the pressure be set to a decompressed state, and be set to from 1.33 Pa to 1.33×10⁴ Pa (0.01 torr to 100 torr) in the end.

The reaction only needs to be performed until a target molecular weight is obtained, and a reaction time is, for example, from 0.2 hour to 10 hours.

The ester exchange reaction, which is performed, for example, in the absence of an inert solvent, may be performed in the presence of 1 part by mass to 150 parts by mass of the inert solvent with respect to 100 parts by mass of the polycarbonate resin to be obtained as required. Examples of the inert solvent include: aromatic compounds, such as diphenyl ether, halogenated diphenyl ether, benzophenone, polyphenyl ether, dichlorobenzene, and methylnaphthalene; and cycloalkanes, such as tricyclo[5.2.1.0^{2,6}]decane, cyclooctane, and cyclodecane.

The reaction may be performed under an inert gas atmosphere as required, and examples of the inert gas include various gases including: gases, such as argon, carbon dioxide, dinitrogen monoxide, and nitrogen; alkanes, such as chlorofluorohydrocarbons, ethane, and propane; and alkenes, such as ethylene and propylene.

In the melt polymerization method, the basic catalyst is preferably used as a catalyst. The basic catalyst may be, for example, at least one kind selected from the group consisting of: a metal catalyst, such as an alkali metal compound or an alkaline earth metal compound; a nitrogen-containing compound; an organic catalyst such as a quaternary phosphonium salt containing an aryl group; and a metal compound. Those compounds may be used alone or in combination thereof.

As the basic catalyst, there is preferably used, for example, any one of the following catalysts: an organic acid salt, an inorganic salt, an oxide, a hydroxide, a hydride, and an alkoxide of an alkali metal or an alkaline earth metal; a quaternary ammonium hydroxide; and a quaternary phosphonium salt containing an aryl group. The basic catalysts may be used alone or in combination thereof.

Examples of the alkali metal compound include sodium hydroxide, potassium hydroxide, cesium hydroxide, lithium hydroxide, sodium hydrogen carbonate, sodium carbonate, potassium carbonate, cesium carbonate, lithium carbonate, sodium acetate, potassium acetate, cesium acetate, lithium acetate, sodium stearate, potassium stearate, cesium stearate, lithium stearate, sodium borohydride, sodium benzoate, potassium benzoate, cesium benzoate, lithium benzoate, disodium hydrogen phosphate, dipotassium hydrogen phosphate, dilithium hydrogen phosphate, disodium phenyl phosphate, disodium salt, dipotassium salt, dicesium salt, or dilithium salt of bisphenol A, and sodium salt, potassium salt, cesium salt, or lithium salt of phenol.

Examples of the alkaline earth metal compound include magnesium hydroxide, calcium hydroxide, strontium hydroxide, barium hydroxide, magnesium carbonate, calcium carbonate, strontium carbonate, barium carbonate, magnesium diacetate, calcium diacetate, strontium diacetate, and barium diacetate.

Examples of the nitrogen-containing compound include: quaternary ammonium hydroxides having alkyl and aryl groups, such as tetramethylammonium hydroxide, tetraethylammonium hydroxide, tetrapropylammonium hydroxide, tetrabutylammonium hydroxide, and trimethylbenzylammonium hydroxide; tertiary amines, such as triethylamine, dimethylbenzylamine, and triphenylamine; imidazoles, such as 2-methylimidazole, 2-phenylimidazole, and benzimidazole; and bases or basic salts, such as ammonia, tetramethylammonium borohydride, tetrabutylammonium borohydride, tetrabutylammonium tetraphenylborate, and tetraphenylammonium tetraphenylborate.

Examples of the metal compound include a zinc-aluminum compound, a germanium compound, an organotin compound, an antimony compound, a manganese compound, a titanium compound, and a zirconium compound.

Specific examples of the quaternary phosphonium salt containing an aryl group include: tetra(aryl or alkyl)phosphonium hydroxides, such as tetraphenylphosphonium hydroxide, tetranaphthylphosphonium hydroxide, tetra(chlorophenyl)phosphonium hydroxide, tetra(biphenyl)phosphonium hydroxide, tetratolylphosphonium hydroxide, tetramethylphosphonium hydroxide, tetraethylphosphonium hydroxide, and tetrabutylphosphonium hydroxide; and tetramethylphosphonium tetraphenylborate, tetraphenylphosphonium bromide, tetraphenylphosphonium phenolate, tetraphenylphosphonium tetraphenylborate, methyltriphenylphosphonium tetraphenylborate, benzyltriphenylphosphonium tetraphenylborate, biphenyltriphenylphosphonium tetraphenylborate, tetratolylphosphonium tetraphenylborate, tetraphenylphosphonium phenolate, tetra(p-t-butylphenyl)phosphonium diphenylphosphate, triphenylbutylphosphonium phenolate, and triphenylbutylphosphonium tetraphenylborate.

The quaternary phosphonium salt containing an aryl group is preferably combined with a nitrogen-containing organic basic compound, and for example, a combination of tetramethylammonium hydroxide and tetraphenylphosphonium tetraphenylborate is preferred.

The usage amount of the basic catalyst may be selected from the range of preferably from 1×10⁻⁹ mol to 1×10⁻² mol, more preferably from 1×10⁻⁸ mol to 1×10⁻² mol, still more preferably from 1×10⁻⁷ mol to 1×10⁻⁸ mol with respect to 1 mol of the diol monomer (a1).

A catalyst deactivator may be added at the later stage of the reaction. A known catalyst deactivator is effectively used as the catalyst deactivator to be used. Examples of the catalyst deactivator include a sulfonic acid ammonium salt and a sulfonic acid phosphonium salt.

When at least one kind of polymerization catalyst selected from alkali metal compounds and alkaline earth metal compounds is used, the usage amount of the catalyst deactivator is preferably from 0.5 mol to 50 mol, more preferably from 0.5 mol to 10 mol, still more preferably from 0.8 mol to 5 mol per 1 mol of the catalyst.

The antioxidant is preferably mixed after the catalyst deactivator has been added to terminate the polymerization reaction.

The reaction in the melt polymerization method may be performed by any one of a continuous system and a batch system. A reactor to be used in melt polymerization may be any one of: a vertical reactor equipped with, for example, an anchor-type stirring blade, a max blend stirring blade, or a helical ribbon-type stirring blade; and a horizontal reactor equipped with, for example, a paddle blade, a lattice blade, or a spectacle blade. Further, the reactor may be of an extruder type equipped with a screw. In the case of the continuous system, an appropriate combination of such reactors is preferably used.

### <Polycarbonate-Based Resin (S)>

The polycarbonate-based resin (S) may contain a polycarbonate-based resin (P) except the polycarbonate-polyorganosiloxane copolymer (A) (hereinafter sometimes referred to as “polycarbonate-based resin (P)”).

The content of the polycarbonate-polyorganosiloxane copolymer (A) in the polycarbonate-based resin (S) is preferably 50 mass % or more, more preferably 60 mass % or more, still more preferably 70 mass % or more, still more preferably 80 mass % or more, still more preferably 90 mass % or more, still more preferably 95 mass % or more, still more preferably 98 mass % or more, still more preferably 99 mass % or more from the viewpoint of improving a balance among the impact resistance, tensile characteristics, and chemical resistance of the resin composition. Although the upper limit of the content of the polycarbonate-polyorganosiloxane copolymer (A) in the polycarbonate-based resin (S) is not particularly limited, the content is, for example, 100 mass % or less from the viewpoint of obtaining a resin composition having desired properties.

The content of the polyorganosiloxane block (A-1) in the polycarbonate-based resin (S) is preferably 0.1 mass % or more, more preferably 0.5 mass % or more, still more preferably 1.0 mass % or more, still more preferably 3.0 mass % or more, and is preferably 40 mass % or less, more preferably 20 mass % or less, still more preferably 10 mass % or less, still more preferably 7.0 mass % or less.

The content of the polyorganosiloxane block (A-1) in the polycarbonate-based resin composition is preferably 0.1 mass % or more, more preferably 0.5 mass % or more, still more preferably 1.0 mass % or more, still more preferably 3.0 mass % or more, and is preferably 40 mass % or less, more preferably 20 mass % or less, still more preferably 10 mass % or less, still more preferably 7.0 mass % or less.

The viscosity-average molecular weight of the polycarbonate-based resin (S) is preferably 5,000 or more, more preferably 12,000 or more, still more preferably 14,000 or more, still more preferably 16,000 or more, and is preferably 50,000 or less, more preferably 30,000 or less, still more preferably 23,000 or less, still more preferably 21,000 or less.

### <Polycarbonate-Based Resin (P)>

Various known polycarbonate-based resins may each be used as the polycarbonate-based resin (P) without any particular limitation.

The polycarbonate-based resin (P) is preferably a polycarbonate-based resin that is free of the polyorganosiloxane block (A-1) including the structural unit represented by the formula (1) and includes the polycarbonate block (A-2) including the structural unit represented by the formula (2).

Examples of the structural unit represented by the formula (2) in the polycarbonate-based resin (P) include the same examples as those of the structural unit represented by the formula (2) in the polycarbonate-polyorganosiloxane copolymer (A). A preferred form thereof is also the same as that described above.

The polycarbonate-based resin (P) preferably includes the structural unit represented by the formula (2) as a main component. The content of the structural unit represented by the formula (2) in the polycarbonate-based resin (P) is preferably 50 mass % or more, more preferably 80 mass % or more, still more preferably 90 mass % or more, still more preferably 98 mass % or more with respect to all the structures of the polycarbonate-based resin (P).

The viscosity-average molecular weight of the polycarbonate-based resin (P) is preferably 5,000 or more, more preferably 12,000 or more, still more preferably 14,000 or more, still more preferably 16,000 or more, and is preferably 50,000 or less, more preferably 30,000 or less, still more preferably 23,000 or less, still more preferably 21,000 or less.

### <Release Agent (B)>

The polycarbonate-based resin composition according to the present invention includes the polycarbonate-based resin (S) and the release agent (B). The polycarbonate-based resin composition preferably includes 0.001 part by mass or more and 2.0 parts by mass or less of the release agent (B) with respect to 100 parts by mass of the polycarbonate-based resin (S). When the content of the release agent (B) is 0.001 part by mass or more, the releasability of the composition can be further improved. When the content of the release agent (B) is 2.0 parts by mass or less, the adhesion of the resin composition to a mold at the time of its molding and a reduction in long-term heat resistance of the resultant molded body can be further suppressed.

From the viewpoint of further improving the releasability, the content of the release agent (B) in the polycarbonate-based resin composition according to the present invention is preferably 0.01 part by mass or more, more preferably 0.10 part by mass or more, still more preferably 0.20 part by mass or more, still further more preferably 0.25 part by mass or more with respect to 100 parts by mass of the polycarbonate-based resin (S). From the viewpoint of further suppressing the adhesion of the resin composition to the mold at the time of its molding and the reduction in long-term heat resistance of the molded body, the content is preferably 1.0 part by mass or less, more preferably 0.50 part by mass or less, still more preferably 0.40 part by mass or less, still more preferably 0.35 part by mass or less.

The polycarbonate-based resin composition according to the present invention may include one or two or more kinds of release agents as the release agent (B).

Examples of the release agent (B) include: an aliphatic carboxylic acid; an ester of an aliphatic carboxylic acid and an alcohol; an aliphatic hydrocarbon having a number-average molecular weight of from 200 to 15,000; a polyether having a number-average molecular weight of from 100 to 5,000; and a polysiloxane-based silicone oil. Among them, an ester of an aliphatic carboxylic acid and an alcohol is preferred.

The aliphatic carboxylic acid is, for example, a saturated or unsaturated, aliphatic, and monovalent, divalent, or trivalent carboxylic acid. Herein, the aliphatic carboxylic acid also encompasses an alicyclic carboxylic acid. Among them, a monovalent or divalent carboxylic acid having 6 to 36 carbon atoms is preferred as the aliphatic carboxylic acid, and an aliphatic, saturated, and monovalent carboxylic acid having 6 to 36 carbon atoms is more preferred. Specific examples of the aliphatic carboxylic acid may include palmitic acid, stearic acid, caproic acid, capric acid, lauric acid, arachic acid, behenic acid, lignoceric acid, cerotic acid, melissic acid, tetratriacontanoic acid, montanic acid, adipic acid, and azelaic acid.

The same acid as the above-mentioned aliphatic carboxylic acid may be used as the aliphatic carboxylic acid in the ester of the aliphatic carboxylic acid and the alcohol. Meanwhile, the alcohol may be, for example, a saturated or unsaturated and monohydric or polyhydric alcohol. Such alcohols may each have a substituent, such as a fluorine atom or an aryl group. Among them, a monohydric or polyhydric and saturated alcohol having 30 or less carbon atoms is preferred, and an aliphatic, saturated, and monohydric or polyhydric alcohol having 30 or less carbon atoms is more preferred. Herein, an aliphatic compound also encompasses an alicyclic compound. Specific examples of the alcohol may include octanol, decanol, dodecanol, stearyl alcohol, behenyl alcohol, ethylene glycol, diethylene glycol, polypropylene glycol, glycerin, pentaerythritol, 2,2-dihydroxyperfluoropropanol, neopentylene glycol, ditrimethylolpropane, and dipentaerythritol.

The ester of the aliphatic carboxylic acid and the alcohol may contain an aliphatic carboxylic acid and/or an alcohol as an impurity, and may be a mixture of a plurality of compounds. Specific examples of the ester of the aliphatic carboxylic acid and the alcohol may include beeswax (a mixture containing myricyl palmitate as a main component), stearyl stearate, behenyl behenate, stearyl behenate, glycerin monopalmitate, glycerin monostearate, glycerin distearate, glycerin tristearate, pentaerythritol monopalmitate, pentaerythritol monostearate, pentaerythritol distearate, pentaerythritol tristearate, and pentaerythritol tetrastearate.

Examples of the aliphatic hydrocarbon having a number-average molecular weight of from 200 to 15,000 include liquid paraffin, a paraffin wax, a micro wax, a polyethylene wax, a Fischer-Tropsch wax, and an α-olefin oligomer having 3 to 12 carbon atoms. Herein, the aliphatic hydrocarbon also encompasses an alicyclic hydrocarbon. In addition, those hydrocarbon compounds may be partially oxidized. Among them, a paraffin wax, a polyethylene wax, and a partially oxidized product of a polyethylene wax are preferred, and a paraffin wax or a polyethylene wax is more preferred. The number-average molecular weight of the aliphatic hydrocarbon is preferably from 200 to 5,000. Such aliphatic hydrocarbon may be a single substance or a mixture of hydrocarbons different from each other in constituent component and molecular weight, and the number-average molecular weight of its main component only needs to fall within the above-mentioned range.

Examples of the polyether having a number-average molecular weight of from 100 to 5,000 include polyethylene glycol, polypropylene glycol, and polytetramethylene ether glycol.

Examples of the polysiloxane-based silicone oil may include a dimethylsilicone oil, a phenylmethylsilicone oil, a diphenylsilicone oil, and a fluorinated alkyl silicone.

The polycarbonate-based resin composition according to the present invention preferably includes, as the release agent (B), at least one kind selected from the group consisting of: an ester of an aliphatic carboxylic acid and pentaerythritol; and an ester of an aliphatic carboxylic acid and glycerin. In addition, the release agent (B) is preferably a full ester, more preferably a full ester of an aliphatic carboxylic acid and pentaerythritol. The term “full ester” as used herein refers to a compound in which all the hydroxyl groups of a polyhydric alcohol compound such as pentaerythritol each form an ester with the carboxy group of a compound having a carboxy group such as an aliphatic carboxylic acid.

An aliphatic carboxylic acid having 12 to 30 carbon atoms may be preferably used as the aliphatic carboxylic acid serving as a constituent component for the ester.

Among the aliphatic carboxylic acids each having 12 to 30 carbon atoms, an aliphatic carboxylic acid having 12 to 22 carbon atoms is preferred. Among the aliphatic carboxylic acids, a saturated fatty acid is preferably used, and a saturated fatty acid having 12 to 22 carbon atoms is more preferably used. Among the saturated fatty acids each having 12 to 22 carbon atoms, stearic acid, palmitic acid, or behenic acid is preferred, and stearic acid is more preferred.

In addition, preferred specific compounds of the full ester of the aliphatic carboxylic acid and pentaerythritol are a pentaerythritol-stearic acid full ester, a pentaerythritol-palmitic acid full ester, and a pentaerythritol-behenic acid full ester. In particular, the following mixture is preferably used from, for example, the viewpoint of considering conformance with the European REACH regulation: a mixing ratio between the pentaerythritol-palmitic acid full ester and the pentaerythritol-stearic acid full ester is from 9:1 to 1:9, preferably from 5:5 to 3:7 in terms of mass ratio. For example, the pentaerythritol-stearic acid full ester has already been preliminarily registered as an existing substance in REACH because the full ester has heretofore been widely used as a release agent as well. In contrast, the pentaerythritol-palmitic acid full ester needs to be newly preliminarily registered as a novel substance. However, cost required for the registration is expensive and a procedure therefor becomes further complicated. Accordingly, a mixture having so high a composition ratio of the pentaerythritol-stearic acid full ester as to be handleable as the pentaerythritol-stearic acid full ester is preferably used. In addition, for example, the following fact is given as a reason why the composition ratio of the pentaerythritol-stearic acid full ester is preferably high: the pentaerythritol-stearic acid full ester having a C18 carbon chain is superior to the pentaerythritol-palmitic acid full ester having a C16 carbon chain in, for example, releasing performance in the case of the production of a resin composition.

The total content of the polycarbonate-based resin (S) and the release agent (B) in the polycarbonate-based resin composition according to the present invention is preferably 50 mass % or more, more preferably 60 mass % or more, still more preferably 70 mass % or more, still more preferably 80 mass % or more, still more preferably 90 mass % or more, still more preferably 95 mass % or more, still more preferably 98 mass % or more, still more preferably 99 mass % or more when the entirety of the polycarbonate-based resin composition is defined as 100 mass % from the viewpoint of further improving the balance between the mechanical strength and releasability of the molded body to be obtained. Although the upper limit of the total content of the polycarbonate-based resin (S) and the release agent (B) is not particularly limited, the total content is, for example, 100 mass % or less from the viewpoint of obtaining a resin composition having desired properties.

### <Antioxidant (C)>

The polycarbonate-based resin composition according to the present invention may appropriately include an antioxidant (C) to the extent that the object of the present invention is not impaired.

The antioxidant (C) can suppress the decomposition of the resins at the time of the production of the polycarbonate-based resin composition and at the time of the molding thereof. A known antioxidant may be used as the antioxidant (C), and at least one kind selected from a phosphorus-based antioxidant and a phenol-based antioxidant may be preferably used.

From the viewpoint of suppressing the oxidative deterioration of a molded body including the polycarbonate-based resin composition at the time of its high-temperature molding, the phosphorus-based antioxidant is more preferably a phosphorus-based antioxidant having an aryl group, still more preferably a compound represented by the following formula (C1):

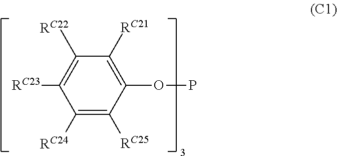

wherein in the formula (C1), R^{C21} to R^{C25} each represent a hydrogen atom, an alkyl group having 1 or more and 12 or less carbon atoms, or an aryl group having 6 or more and 14 or less carbon atoms, and may be identical to or different from each other, provided that in terms of effect as an antioxidant, a case in which all of R^{C21} to R^{C25} represent hydrogen atoms is excluded, and at least two of R^{C21} to R^{C25} each represent an alkyl group having 1 or more and 12 or less carbon atoms, or an aryl group having 6 or more and 14 or less carbon atoms. A compound in which any two of R^{C21} to R^{C25} each represent an alkyl group having 1 or more and 12 or less carbon atoms, or an aryl group having 6 or more and 14 or less carbon atoms, and the others represent hydrogen atoms is preferred. Among the compounds in each of which any two of R^{C21} to R^{C25} each represent an alkyl group having 1 or more and 12 or less carbon atoms, or an aryl group having 6 or more and 14 or less carbon atoms, and the others represent hydrogen atoms, a compound in which at least one of R^{C21} or R^{C25} represents an alkyl group having 1 to 12 carbon atoms, or an aryl group having 6 or more and 14 or less carbon atoms is more preferred.

Examples of the alkyl group having 1 or more and 12 or less carbon atoms include a methyl group, an ethyl group, a n-propyl group, an isopropyl group, various butyl groups, various pentyl groups, various hexyl groups, various octyl groups, various decyl groups, and various dodecyl groups. Among them, one or more kinds selected from the group consisting of: a methyl group; an ethyl group; a n-propyl group; an isopropyl group; various butyl groups; various pentyl groups; various hexyl groups; and various octyl groups are preferred, one or more kinds selected from the group consisting of: a methyl group; an ethyl group; an isopropyl group; and a tert butyl group are more preferred, and a tert butyl group is still more preferred from the viewpoint of imparting long-term moist heat resistance and long-term heat resistance.

Examples of the aryl group having 6 or more and 14 or less carbon atoms include a phenyl group, a tolyl group, and a xylyl group. R^{C21} to R^{C25} each represent more preferably a hydrogen atom, or an alkyl group having 1 or more and 12 or less carbon atoms, still more preferably a hydrogen atom, a methyl group, an ethyl group, an isopropyl group, or a tert butyl group, still more preferably a hydrogen atom or a tert butyl group among the above-mentioned groups from the viewpoint that the thermal decomposition of the resin composition hardly occurs, and hence improving effects on the long-term moist heat resistance and the long-term heat resistance are excellent.

Such a compound that R^{C21} and R^{C23} each represent a tert-butyl group, and R^{C22}, R^{C21}, and R^{C25} each represent a hydrogen atom, that is, tris(2,4-di-tert butylphenyl)phosphite is particularly preferred.

Examples of the phosphorus-based antioxidant include triphenyl phosphite, diphenyl nonyl phosphite, diphenyl (2-ethylhexyl) phosphite, tris(2,4-di-tert-butylphenyl) phosphite, tris(nonylphenyl) phosphite, diphenyl isooctyl phosphite, 2,2′-methylenebis(4,6-di-tert butylphenyl)octyl phosphite, diphenyl isodecyl phosphite, diphenyl mono(tridecyl) phosphite, phenyl diisodecyl phosphite, phenyl di(tridecyl) phosphite, tris(2-ethylhexyl) phosphite, tris(isodecyl) phosphite, tris(tridecyl) phosphite, dibutyl hydrogen phosphite, trilauryl trithiophosphite, tetrakis(2,4-di-tert-butylphenyl)-4,4′-biphenylene diphosphonite, 4,4′-isopropylidenediphenol dodecyl phosphite, 4,4′-isopropylidenediphenol tridecyl phosphite, 4,4′-isopropylidenediphenol tetradecyl phosphite, 4,4′-isopropylidenediphenol pentadecyl phosphite, 4,4′-butylidenebis(3-methyl-6-tert-butylphenyl)ditridecyl phosphite, bis(2,6-di-tert-butyl-4-methylphenyl)pentaerythritol diphosphite, bis(nonylphenyl)pentaerythritol diphosphite, distearyl-pentaerythritol diphosphite, phenyl bisphenol A pentaerythritol diphosphite, tetraphenyl dipropylene glycol diphosphite, 1,1,3-tris(2-methyl-4-di-tridecylphosphite-5-tert-butylphenyl)butane, 3,4,5,6-dibenzo-1,2-oxaphosphane, triphenylphosphine, diphenylbutylphosphine, diphenyloctadecylphosphine, tris(p-tolyl)phosphine, tris(p-nonylphenyl)phosphine, tris(naphthyl)phosphine, diphenyl(hydroxymethyl)phosphine, diphenyl(acetoxymethyl)phosphine, diphenyl(6-ethylcarboxyethyl)phosphine, tris(p-chlorophenyl)phosphine, tris(p-fluorophenyl)phosphine, benzyldiphenylphosphine, diphenyl(6-cyanoethyl)phosphine, diphenyl(p-hydroxyphenyl)phosphine, diphenyl(1,4-dihydroxyphenyl)-2-phosphine, phenylnaphthylbenzylphosphine, and bis(2,4-dicumylphenyl)pentaerythritol diphosphite.

Specific examples of the phosphorus-based antioxidant may include commercial products, such as “Irgafos 168” (manufactured by BASF Japan Ltd., trademark), “Irgafos 12” (manufactured by BASF Japan Ltd., trademark), “Irgafos 38” (manufactured by BASF Japan Ltd., trademark), “ADK STAB 329K” (manufactured by ADEKA Corporation, trademark), “ADK STAB PEP-36” (manufactured by ADEKA Corporation, trademark), “ADK STAB PEP-8” (manufactured by ADEKA Corporation, trademark), “Sandstab P-EPQ” (manufactured by Clariant AG, trademark), “Weston 618” (manufactured by General Electric Company, trademark), “Weston 619G” (manufactured by General Electric Company, trademark), and “Weston 624” (manufactured by General Electric Company, trademark), and “Doverphos S-9228PC” (manufactured by Dover Chemical Corporation).

The phenol-based antioxidant is preferably a hindered phenol. Specific examples of the phenol-based antioxidant include triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], pentaerythritol-tetrakis[3-(3,5-di-tert-butyl-4-hydroxyphenyl)propionate], octadecyl-3-(3,5-di-tert-butyl-4-hydroxyphenyl)propionate, 1,3,5-trimethyl-2,4,6-tris(3,5-di-tert-butyl-4-hydroxybenzyl)benzene, N,N-hexamethylenebis(3,5-di-tert-butyl-4-hydroxy-hydrocinnamide), 3,5-di-tert-butyl-4-hydroxy-benzylphosphonate diethyl ester, tris(3,5-di-tert-butyl-4-hydroxybenzyl) isocyanurate, and 3,9-bis[1,1-dimethyl-2-[β-(3-tert-butyl-4-hydroxy-5-methylphenyl)propionyloxylethyl]-2,4,8,10-tetraoxaspiro(5,5)undecane.

Specific examples of the phenol-based antioxidant may include commercial products, such as “Irganox 1010” (manufactured by BASF Japan Ltd., trademark), “Irganox 1076” (manufactured by BASF Japan Ltd., trademark), “Irganox 1330” (manufactured by BASF Japan Ltd., trademark), “Irganox 3114” (manufactured by BASF Japan Ltd., trademark), “Irganox 3125” (manufactured by BASF Japan Ltd., trademark), “BHT” (manufactured by Takeda Pharmaceutical Company Limited, trademark), “Cyanox 1790” (manufactured by Cyanamid Company, trademark), and “Sumilizer GA-80” (manufactured by Sumitomo Chemical Company, Limited, trademark).

The antioxidants (C) may be used alone or in combination thereof. The content of the antioxidant (C) in the polycarbonate-based resin composition according to the present invention is preferably 0.001 part by mass or more, more preferably 0.01 part by mass or more, still more preferably 0.04 part by mass or more, still more preferably 0.08 part by mass or more, and is preferably 1.0 part by mass or less, more preferably 0.50 part by mass or less, still more preferably 0.25 part by mass or less, still more preferably 0.15 part by mass or less with respect to 100 parts by mass of the polycarbonate-based resin (S). When the plurality of kinds of antioxidants (C) are used, the total amount thereof falls within the above-mentioned ranges.

### <Additive>

The polycarbonate-based resin composition according to the present invention may appropriately include an additive except the release agent (B) and the antioxidant (C) to the extent that the object of the present invention is not impaired.

Examples of the additive include various fillers, a heat stabilizer, a plasticizer, a light stabilizer, a polymerization metal deactivator, a flame retardant, a lubricant, an antistatic agent, a surfactant, an antimicrobial agent, and a UV absorber.

A method of producing the polycarbonate-based resin composition according to the present invention is not particularly limited as long as the method includes a step of mixing the polycarbonate-based resin (S), the release agent (B), and an optional additive. The composition may be produced by, for example, mixing the polycarbonate-based resin (S), the release agent (B), and the optional additive with a mixer or the like, and melting and kneading the mixture. The melting and kneading may be performed by a method that has been typically employed, for example, a method including using a ribbon blender, a Henschel mixer, a Banbury mixer, a drum tumbler, a single-screw extruder, a twin-screw extruder, a co-kneader, a multi-screw extruder, or the like. A heating temperature at the time of the melting and kneading is appropriately selected from the range of, for example, from about 150° C. to about 300° C., preferably from about 220° C. to about 300° C.

From the viewpoint of further improving the mechanical strength of the molded body to be obtained, the tensile modulus of elasticity of a molded piece having a total length of 75 mm, a parallel-portion length of 30 mm, an end-portion width of 10 mm, a central parallel-portion width of 5 mm, and a thickness of 2 mm of a JIS K 7139:2009 dumbbell-shaped tensile test piece type A22, which is obtained by molding the polycarbonate-based resin composition according to the present invention, is preferably 2,400 MPa or more, more preferably 2,450 MPa or more. The tensile modulus of elasticity is preferably as high as possible from the viewpoint of further improving the mechanical strength of the molded body to be obtained, and hence its upper limit value is not particularly limited. However, from the viewpoint of improving the impact resistance of the molded body, the tensile modulus of elasticity is preferably 10,000 MPa or less, more preferably 5,000 MPa or less, still more preferably 3,000 MPa or less.

The tensile modulus of elasticity may be measured under the conditions of a tensile rate of 25 mm/min, a measurement temperature of 23° C., and a chuck-to-chuck distance of 57 mm, and may be specifically measured by a method described in Examples to be described later.

Conditions for the molding of the above-mentioned molded piece are a cylinder temperature of 280° C., a mold temperature of 100° C., and a cycle time of 60 seconds. Specifically, the molded piece is obtained by a method described in Examples to be described later.

From the viewpoint of further improving the mechanical strength of the molded body to be obtained, the tensile yield stress of a molded piece having a total length of 75 mm, a parallel-portion length of 30 mm, an end-portion width of 10 mm, a central parallel-portion width of 5 mm, and a thickness of 2 mm of a JIS K 7139:2009 dumbbell-shaped tensile test piece type A22, which is obtained by molding the polycarbonate-based resin composition according to the present invention, is preferably 45 MPa or more, more preferably 50 MPa or more, still more preferably 55 MPa or more. The tensile yield stress is preferably as high as possible from the viewpoint of further improving the mechanical strength of the molded body to be obtained, and hence its upper limit value is not particularly limited. However, from the viewpoint of improving the impact resistance of the molded body, the tensile yield stress is preferably 200 MPa or less, more preferably 150 MPa or less, still more preferably 100 MPa or less, still more preferably 80 MPa or less.

The tensile yield stress may be measured under the conditions of a tensile rate of 25 mm/min, a measurement temperature of 23° C., and a chuck-to-chuck distance of 57 mm, and may be specifically measured by a method described in Examples to be described later.

Conditions for the molding of the above-mentioned molded piece are a cylinder temperature of 280° C., a mold temperature of 100° C., and a cycle time of 60 seconds. Specifically, the molded piece is obtained by a method described in Examples to be described later.

### 2. Molded Body

A molded body of the present invention includes the polycarbonate-based resin composition of the present invention. The molded body may be produced through use of a melt-kneaded product of the polycarbonate-based resin composition or a pellet thereof obtained through melting and kneading as a raw material by any one of, for example, an injection molding method, an injection compression molding method, an extrusion molding method, a blow molding method, a press molding method, a vacuum molding method, and an expansion molding method. In particular, the molded body is preferably produced through use of the resultant pellet by the injection molding method or the injection compression molding method.

The thickness of the molded body may be arbitrarily set in accordance with its applications. In particular, when the transparency of the molded body is required, the thickness is preferably from 0.2 mm to 4.0 mm, more preferably from 0.3 mm to 3.0 mm, still more preferably from 0.3 mm to 2.0 mm. When the thickness of the molded body is 0.2 mm or more, its warping does not occur and good mechanical strength is obtained. In addition, when the thickness of the molded body is 4.0 mm or less, high transparency is obtained.

A coating film formed of a hard coating film, an antifogging film, an antistatic film, or an antireflection film may be formed on the molded body as required, and a composite coating film formed of two or more kinds thereof may be formed.

Among them, a coating film formed of a hard coating film is preferably formed because the film has good weatherability and can prevent the wear of the surface of the molded body with time. A material for the hard coating film is not particularly limited, and a known material, such as an acrylate-based hard coating agent, a silicone-based hard coating agent, or an inorganic hard coating agent, may be used.

The molded body according to the present invention can be suitably used in, for example: 1) automobile parts, such as a sunroof, a door visor, a rear window, and a side window; 2) building parts, such as a building glass, a soundproof wall, a car port, a sunroom, and gratings; 3) windows for railway vehicles and ships; 4) parts for electrical instruments, such as various parts for a television, a radio cassette recorder, a video camera, a video tape recorder, an audio player, a DVD player, a telephone, a display, a computer, a register, a copying machine, a printer, a facsimile, and the like, and respective parts for outer plates or housings thereof; 5) parts for precision instruments, such as casings or covers for precision machines, such as a cellular phone, a PDA, a camera, a slide projector, a watch, an electronic calculator, a measuring instrument, and a display instrument; 6) agricultural parts, such as a vinyl house and a greenhouse; and 7) furniture parts, such as a lighting cover, blinds, and interior tools.

### EXAMPLES

The present invention is described in more detail below by way of Examples, but the present invention is not limited to these Examples. In this description, a polydimethylsiloxane is sometimes abbreviated as “PDMS”.

### 1. Production of Terminal-Modified Polyorganosiloxane

### Production Example 1: Production of PDMS-1

Under a nitrogen atmosphere, to a polyorganosiloxane (100 g) having an average number of repeating units of 45, which was represented by the following formula:

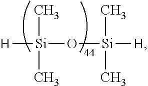

a polyethylene glycol having an average oxyethylene chain length of 12, which was represented by the following formula:

H₂C═CH—CH₂—O—(CH₂CH₂O)₁₂—H,

was added in a molar amount (35.3 g) twice as large as that of the polyorganosiloxane. 338 Grams of toluene was added as a solvent to the mixture, and then the whole was sufficiently stirred while its temperature was kept at 80° C. Next, a solution of a vinylsiloxane complex of platinum in toluene was added to the resultant in such an amount that the ratio of the mass of a platinum atom to that of the siloxane (—(SiMe₂O)ₙ—) became 5 ppm by mass, followed by stirring at a reaction temperature of 110° C. for 10 hours. Toluene and the platinum catalyst were removed from the resultant mixture. Thus, a polyether modified polyorganosiloxane PDMS-1 was obtained.

### Production Example 2: Production of PDMS-2

A polyether-modified polyorganosiloxane PDMS-2 was produced in the same manner as in Production Example 1 except that the average oxyethylene chain length of the polyethylene glycol was set to 38.

### Production Example 3: Production of PDMS-3

Under a nitrogen atmosphere, to a polyorganosiloxane having an average number of repeating units of 39, which was represented by the following formula:

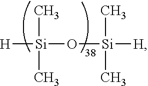

2-allylphenol was added in a molar amount twice as large as that of the polyorganosiloxane. After that, the mixture was sufficiently stirred while its temperature was kept at 100° C. Next, a solution of a vinylsiloxane complex of platinum in toluene was added to the mixture in such an amount that the ratio of the mass of a platinum atom to that of the siloxane (—(SiMe₂O)ₙ—) became 5 ppm by mass, followed by stirring at a reaction temperature of 100° C. for 10 hours. The platinum catalyst was removed from the resultant mixture. Thus, an allylphenol-modified polyorganosiloxane PDMS-3 was obtained.

The structural formulae of the PDMS-1 to the PDMS-3 obtained in Production Examples 1 to 3 are shown in Table 1.

TABLE 1

| | |
|---|---|
| Production Example 1 | 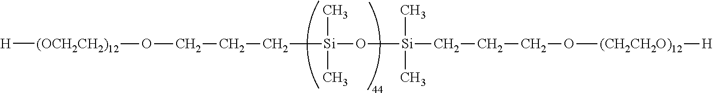 |
| Production Example 2 | 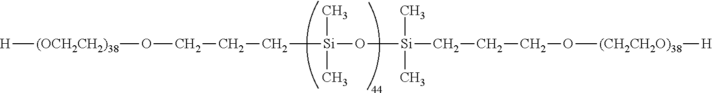 |
| Production Example 3 | 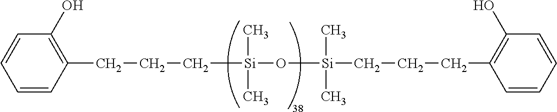 |

<Methods of measuring Average Number of Repeating Units of Polyorganosiloxane and Average Number of Repeating Units of Terminal Modified Group of Polyorganosiloxane>

The average number of the repeating units of a polyorganosiloxane was calculated from the integrated value ratio of a methyl group of a polydimethylsiloxane by NMR measurement. The average number of the repeating units of a terminal modified group of the polyorganosiloxane was calculated from the integrated value ratio of a dimethylene group of a polyethylene glycol by NMR measurement.

¹H-NMR measurement conditions
NMR apparatus: ECA-500 manufactured by JEOL RESONANCE Inc.
Probe: 50TH5AT/FG2
Observation range: From −5 ppm to 15 ppm
Observation center: 5 ppm
Pulse repetition time: 9 seconds
Pulse width: 45°
NMR sample tube: 5φ
Sample amount: From 30 mg to 40 mg
Solvent: Deuterated chloroform
Measurement temperature: 23° C.
Number of scans: 256 times

### 2. Production of Polycarbonate-Polyorganosiloxane (PC-POS) Copolymer

### Production Example 4: Production of PC-POS Copolymer 1

A polycarbonate-polyorganosiloxane copolymer was produced by using the following raw materials under the following conditions.

BisP-A (2,489.9 g) serving as a diol monomer and DPC (2,500 g) serving as a carbonic acid diester compound (molar ratio between the respective raw materials: BisP-A/DP=100/107), and 179.7 g of the polyether-modified polyorganosiloxane PDMS-1 were loaded into a 10-liter stainless steel-made reactor including a stirring apparatus, a trap for trapping distilled phenol, and a decompression apparatus, and these raw material monomers were completely melted at 150° C., followed by the purging of air in the reactor with nitrogen. 1.64 Milliliters (amount 1.5×10⁻⁶ times as large as the number of moles of the entire diol monomer) of 0.01 mol/L sodium hydroxide was loaded as a catalyst into the reactor to initiate polymerization. A temperature in the reactor was increased to 180° C., and a pressure in the reactor was reduced to an 200 mmHg (26.6 kPa), over about 60 minutes, and the reaction conditions were held until the amount of phenol to be distilled out became 0.2 L. After that, the temperature in the reactor was increased to 200° C., and the pressure in the reactor was reduced to 10 mmHg (1.3 kPa), over about 60 minutes, and the conditions were held until 1.0 L of phenol was distilled out.

Next, the temperature in the reactor was increased to 240° C. over about 120 minutes, and the condition was held until 1.5 L of phenol was distilled out. Subsequently, the temperature in the reactor and the pressure in the reactor were adjusted to 280° C. and 1 mmHg (0.1 kPa) or less, respectively over about 120 minutes, and 2 L or more of phenol was distilled out, followed by the continuation of the reaction until a predetermined stirring torque was obtained. After that, nitrogen was introduced into the reactor to return the pressure to normal pressure, and 0.037 g (amount 10 times as large as the number of moles of NaOH) of butyl p-toluenesulfonate was loaded as a deactivator thereinto. Each of the following antioxidant 1 and antioxidant 2 was loaded into the reactor so that its amount became 0.05 part by mass with respect to a polymer to be obtained, followed by sufficient stirring. After that, a resin strand was extracted from the bottom portion of the reactor with the pressure of nitrogen, and the strand was cut with a pelletizer to provide a polycarbonate-polyorganosiloxane copolymer.

The analysis values of the resultant PC-POS copolymer 1 are shown in Table 2.

The raw materials used in the production are as described below.
BisP-A: bisphenol A [manufactured by Idemitsu Kosan Co., Ltd.]
DPC: diphenyl carbonate [manufactured by Mitsui Fine Chemicals, Inc.]
0.01 mol/L sodium hydroxide aqueous solution [manufactured by Fujifilm Wako Pure Chemical Corporation]
Antioxidant (C)
   Antioxidant 1: tris(2,4-di-tert-butylphenyl)phosphite [manufactured by BASF Japan Ltd., Irgafos 168]
   Antioxidant 2: pentaerythritol-tetrakis[3-(3,5-di-tert-butyl-4-hydroxyphenyl)propionate] [manufactured by BASF Japan Ltd., Irganox 1010]

### Production Example 5: Production of PC-POS Copolymer 2

A PC-POS copolymer 2 was obtained through polymerization under the same conditions as those of Production Example 4 except that 179.7 g of the PDMS-2 was used as a polyorganosiloxane instead of the PDMS-1.

The analysis values of the resultant PC-POS copolymer 2 are shown in Table 2.

### Production Example 6: Production of PC-POS Copolymer 3

A PC-POS copolymer 3 was obtained through polymerization under the same conditions as those of Production Example 4 except that 179.7 g of the PDMS-3 was used as a polyorganosiloxane instead of the PDMS-1.

The analysis values of the resultant PC-POS copolymer 3 are shown in Table 2.

### 2. Measurement of Physical Properties of Polycarbonate-Polyorganosiloxane Copolymer

(1) Method of determining Content of Polydimethylsiloxane in Resultant Polycarbonate-Polyorganosiloxane Copolymer
NMR apparatus: ECA-500 manufactured by JEOL RESONANCE Inc.
Probe: TH5 corresponding to a 5 q NMR sample tube
Observation range: From −5 ppm to 15 ppm
Observation center: 5 ppm
Pulse repetition time: 9 seconds
Pulse width: 45°
Number of scans: 256 times
NMR sample tube: 5φ
Sample amount: From 30 mg to 40 mg
Solvent: Deuterated chloroform
Measurement temperature: 23° C.
A: The integrated value of the meta position of a phenyl moiety observed at a 8 of from about 7.3 to about 7.5
B: The integrated value of a methylene group of a PEG moiety observed at a 8 of from about 3.3 to about 4.5
C: The integrated value of a methyl group of a bisphenol A moiety observed at a 8 of from about 1.50 to about 2.00
D: The integrated value of a methyl group of a dimethylsiloxane moiety observed at a 8 of from about −0.02 to about 0.4
E: The integrated value of a methylene group of a dimethylsiloxane terminal moiety observed at a δ of about 0.52

$$\begin{matrix}a = A / 2 \\ b = B / 4 \\ c = ( C - e \times 2 ) / 6 \\ d = D / 6 \\ e = E / 2 \\ T = a + b + c + d \\ f = a / T \times 100 \\ g = b / T \times 100 \\ h = c / T \times 100 \\ i = d / T \times 100 \\ TW = f \times 93 + g \times 44 + h \times 254 + i \times 74.1 \\ PDMS ( wt \% ) = ( i \times 74 \text{.1} ) / TW \times 100\end{matrix}$$

### (2) Method of Measuring Viscosity-Average Molecular Weight of Polycarbonate-Polyorganosiloxane Copolymer

The viscosity-average molecular weight (Mv) of a polycarbonate-polyorganosiloxane copolymer was calculated from the following equation (Schnell's equation) by using a limiting viscosity [n] determined through the measurement of the viscosity of a solution (concentration: g/L) thereof in methylene chloride at 20° C. with an Ubbelohde-type viscometer.

$$[ η ] = 1.23 \times 1 {0}^{- 5} M {v}^{0.83}$$

TABLE 2

| | | | | PC-POS copolymer | | |
|---|---|---|---|---|---|---|
| | | | Unit | 1 | 2 | 3 |
| Loading | Diol monomer (a1) | BisP-A | Molar | 100 | 100 | 100 |
| condition | Carbonic acid | DPC | ratio | 107 | 107 | 107 |
| | diester | | | | | |
| | Polyorganosiloxane | PDMS-1 | mass %* | 6 | | |
| | (a2) | PDMS-2 | | | 6 | |
| | | PDMS-3 | | | | 6 |

| | | | | | |
|---|---|---|---|---|---|
| PC-POS copolymer | Polydimethylsiloxane | mass % | 4.6 | 3.1 | 5.3 |
| | content | | | | |
| | Viscosity | Mv | 20,100 | 20,050 | 20,150 |
| | average | | | | |
| | molecular | | | | |
| | weight | | | | |

*The unit represents the mass percentage of the loaded polyorganosiloxane (a2) with respect to the mass (theoretical value) of a PC-POS copolymer to be obtained.

The mass (theoretical value) of the PC-POS copolymer to be obtained was calculated from the expression “[loading mass of diol monomer (a1)+loading mass of carbonic acid diester+loading mass of polyorganosiloxane mass (a2)−mass of produced phenol (theoretical value, phenol whose molar amount was twice as large as that of the carbonic acid diester)].”

### 3. Used Raw Materials (Resins and Additives)

The following raw materials were used in Examples and Comparative Examples.

### (1) Polycarbonate-Polyorganosiloxane Copolymer (A) (Including, However, Antioxidant (C))

PC-POS copolymer 1: Production Example 4 described above
PC-POS copolymer 2: Production Example 5 described above

### (2) Polycarbonate-Polyorganosiloxane Copolymer (Including, However, Antioxidant (C)) Except Polycarbonate-Polyorganosiloxane Copolymer (A)

PC-POS copolymer 3: Production Example 6 described above

### (3) Release Agent (B)

Release agent 1: A mixture of a pentaerythritol-stearic acid full ester and a pentaerythritol-palmitic acid full ester (having a mixing ratio “C16:C18” of 1:1.1) [manufactured by Riken Vitamin Co., Ltd., EW440A]

### 4. Examples 1 and 2, and Comparative Examples 1 to 3

### (1) Production of Polycarbonate-Based Resin Composition

The respective components were mixed at ratios shown in Table 3, and were supplied to a twin-screw extrusion molding machine [manufactured by DSM Xplore: Micro 15 cc Twin Screw Compounder], followed by melting and kneading at a barrel temperature of 280° C. and a screw revolution number of 50 rpm. Thus, polycarbonate-based resin compositions were each obtained.

Herein, the blending amounts of the respective components shown in Table 3 are each represented in the unit of part(s) by mass.

### (2) Production of Evaluation Molded Piece

The polycarbonate-based resin compositions obtained in the section (1) were each subjected to injection molding with an injection molding machine [manufactured by DSM Xplore: 10cc Injection Moulding Machine] under the conditions of a cylinder temperature of 280° C., a mold temperature of 100° C., and a cycle time of 60 seconds to mold molded pieces (molded bodies) for the evaluations of tensile characteristics and releasability.

### (3) Evaluations

The following respective evaluations were performed by using the evaluation molded pieces obtained in the section (2). The results are shown in Table 3.
Tensile Characteristics (Tensile Yield Stress and Tensile Modulus of Elasticity)

The tensile yield stress and tensile modulus of elasticity of the resultant molded piece having a total length of 75 mm, a parallel-portion length of 30 mm, an end-portion width of 10 mm, a central parallel-portion width of 5 mm, and a thickness of 2 mm of a JIS K 7139:2009 dumbbell-shaped tensile test piece type A22 were measured with a tensile tester [manufactured by Instron: 5567] under the conditions of a tensile rate of 25 mm/min, a measurement temperature of 23° C., and a chuck-to-chuck distance of 57 mm. A larger numerical value means that the mechanical strength of the molded piece is more satisfactory.
Releasability

A strip-shaped molded piece having a length of 80 mm, a width of 10 mm, and a thickness of 4 mm was produced with a mold, and its releasability was evaluated from the ease with which the molded piece was removed from the mold with a pair of tweezers and the appearance of the molded piece after its mold release by the following criteria.
A: The molded piece can be smoothly released, and fine peeling and fluffing are absent in the parting line portion of the mold.
B: The molded piece can be smoothly released, but fine peeling and/or fluffing is present in the parting line portion of the mold.
C: A force is required at the time of the mold release, and the molded piece is caught in the cavity of the mold at the time of the mold release.

TABLE 3

| | | | Example | Example | Comparative | Comparative | Comparative |
|---|---|---|---|---|---|---|---|
| | | | 1 | 2 | Example 1 | Example 2 | Example 3 |
| PC-POS | PC-POS | part(s) | 100 | | | 100 | |
| copolymer (A) | copolymer 1 | by mass | | | | | |
| | PC-POS | part(s) | | 100 | | | |
| | copolymer 2 | by mass | | | | | |
| PC-POS | PC-POS | part(s) | | | 100 | | 100 |
| copolymer | copolymer 3 | by mass | | | | | |
| except PC-POS | | | | | | | |
| copolymer (A) | | | | | | | |
| Release agent (B) | Release | part(s) | 0.3 | 0.3 | 0.3 | | |
| | agent 1 | by mass | | | | | |
| Antioxidant (C) | Antioxidant 1 | part(s) | 0.05 | 0.05 | 0.05 | 0.05 | 0.05 |
| | | by mass | | | | | |
| | Antioxidant 2 | part(s) | 0.05 | 0.05 | 0.05 | 0.05 | 0.05 |
| | | by mass | | | | | |
| Evaluation result | Tensile yield | MPa | 57 | 65 | 42 | 60 | 37 |
| | stress | | | | | | |
| | Tensile | MPa | 2,500 | 2,600 | 2,300 | 2,500 | 2,200 |
| | modulus of | | | | | | |
| | elasticity | | | | | | |
| | Releasability | — | A | A | B | C | B |

1. A polycarbonate-based resin composition, comprising:
a polycarbonate-based resin (S) containing a polycarbonate-polyorganosiloxane copolymer (A) having a polyorganosiloxane block (A-1) including a structural unit represented by the formula (1) and a polycarbonate block (A-2) including a structural unit represented by the formula (2); and
a release agent (B): 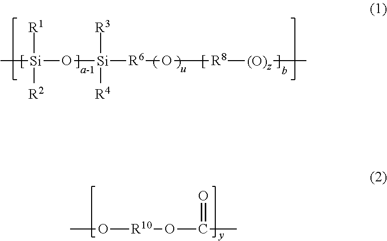
wherein R¹ to R⁴ each independently represent a hydrogen atom, a halogen atom, an alkyl group having 1 to 10 carbon atoms, an alkoxy group having 1 to 10 carbon atoms, an aryl group having 6 to 12 carbon atoms, or an alkylaryl group having 7 to 22 carbon atoms, R⁶ represents an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, a plurality of R⁸s may be identical to or different from each other, and each represent an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, R¹¹¹ represents an alkyl group having 1 to 10 carbon atoms, or an aryl group having 6 to 10 carbon atoms, “z” and “u” each represent 0 or 1, “a” represents an integer of from 2 to 500, “b” represents an integer of from 2 to 200, R¹⁰ represents a divalent aliphatic hydrocarbon group having 2 to 40 carbon atoms, a divalent alicyclic hydrocarbon group having 3 to 40 carbon atoms, or a divalent aromatic hydrocarbon group having 6 to 20 carbon atoms, and these groups may each be substituted with a substituent, and may each contain at least one atom selected from the group consisting of: an oxygen atom; a nitrogen atom; a sulfur atom; and a halogen atom, and “y” represents an integer of from 10 to 500.

2. The polycarbonate-based resin composition according to claim 1, wherein the polycarbonate block (A-2) includes at least one of a structural unit represented by the formula (111) or a structural unit represented by the formula (112): 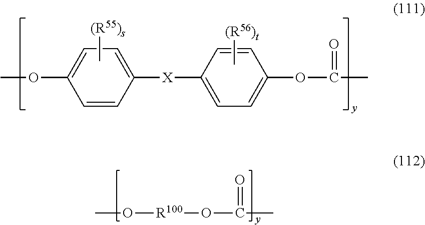
wherein R⁵⁵ and R⁵⁶ each independently represent a halogen atom, an alkyl group having 1 to 6 carbon atoms, or an alkoxy group having 1 to 6 carbon atoms, X represents a single bond, an alkylene group having 1 to 8 carbon atoms, an alkylidene group having 2 to 8 carbon atoms, a cycloalkylene group having 5 to 15 carbon atoms, an arylene group having 6 to 20 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, R¹⁰⁰ represents a divalent aliphatic hydrocarbon group having 2 to 40 carbon atoms, and the divalent aliphatic hydrocarbon group may include at least one selected from the group consisting of: a branched structure; and a cyclic structure, and may contain at least one atom selected from the group consisting of: an oxygen atom; a nitrogen atom; a sulfur atom; and a halogen atom, “y” represents an integer of from 10 to 500, and “s” and “t” each independently represent an integer of from 0 to 4.

3. The polycarbonate-based resin composition according to claim 1, wherein the polycarbonate block (A-2) includes a structural unit derived from at least one compound selected from the group consisting of: 2,2-bis(4-hydroxyphenyl)propane; 2,2-bis(4-hydroxy-3-methylphenyl)propane; 1,1-bis(4-hydroxyphenyl)cyclohexane; 1,1-bis(4-hydroxyphenyl)-3-methylcyclohexane; 1,1-bis(4-hydroxyphenyl)-3,3,5-trimethylcyclohexane; 1,1-bis(4-hydroxyphenyl)cyclododecene; isosorbide; cyclohexane-1,4-dimethanol; tricyclodecane dimethanol; 3,9-bis(1,1-dimethyl-2-hydroxyethyl)-2,4,8,10-tetraoxaspiro[5.5]undecane; 1,3-propanediol; and 1,4-butanediol.

4. The polycarbonate-based resin composition according to claim 1, wherein the polycarbonate block (A-2) includes at least one selected from the group consisting of structural units represented by the formulae (a-i) to (a-v).

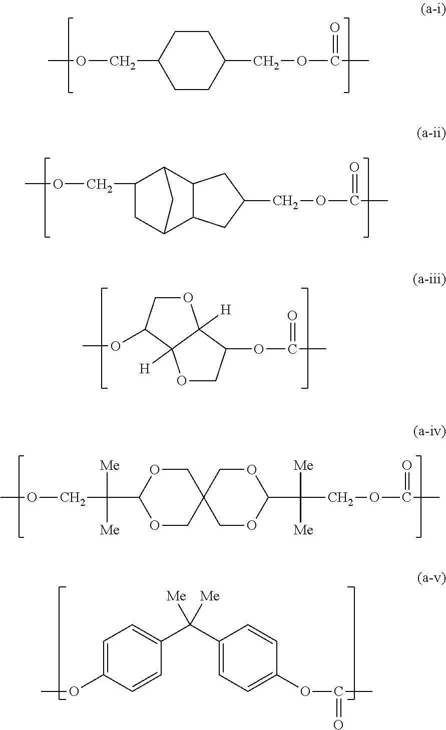

5. The polycarbonate-based resin composition according to claim 1, wherein the “a” represents an integer of 2 or more and 300 or less.

6. The polycarbonate-based resin composition according to claim 1, wherein the “b” represents 10 or more.

7. The polycarbonate-based resin composition according to claim 1, wherein the polyorganosiloxane block (A-1) includes at least one selected from the group consisting of structural units represented by the formulae (1-1) to (1-3): 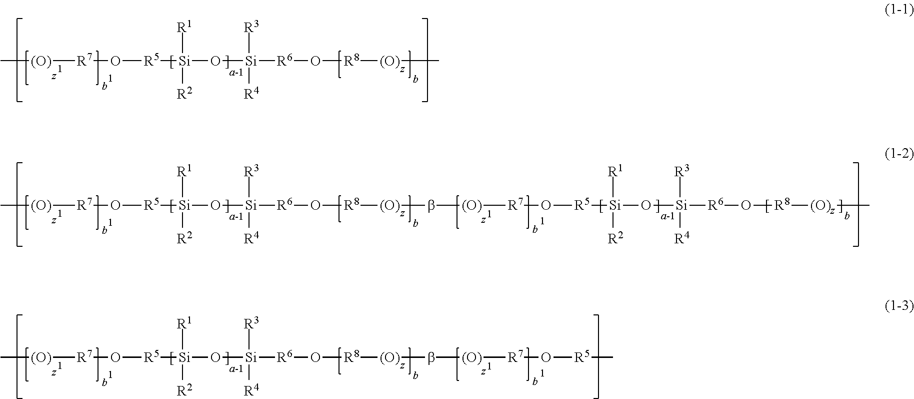
wherein R¹ to R⁴, R⁶, R⁸, “z”, “a”, and “b” each represent the same meaning as that described above, R⁵ represents an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, R⁷ represents an arylene group having 6 to 20 carbon atoms, an alkylene group having 1 to 10 carbon atoms, or an alkylarylene group having 7 to 22 carbon atoms, and these groups may each contain, in at least one of a main chain or a side chain thereof, at least one group selected from the group consisting of: —O—; —COO—; —CO—; —S—; —NH—; and —NR¹¹¹—, R¹¹¹ represents an alkyl group having 1 to 10 carbon atoms, or an aryl group having 6 to 10 carbon atoms, z¹ represents 0 or 1, b1 represents an integer of from 2 to 200, and β represents a divalent group derived from a diisocyanate compound, or a divalent group derived from a dicarboxylic acid or a dicarboxylic acid halide.

8. The polycarbonate-based resin composition according to claim 1, wherein all of the R¹ to the R⁴ represent methyl groups.

9. The polycarbonate-based resin composition according to claim 1, wherein the R⁶ represents a trimethylene group.

10. The polycarbonate-based resin composition according to claim 1, wherein the R⁸ represents a dimethylene group, a methyl-substituted dimethylene group (—CH₂CHMe-), or a trimethylene group, and the “z” represents 1.

11. The polycarbonate-based resin composition according to claim 1, wherein a content of the polyorganosiloxane block (A-1) in the polycarbonate-polyorganosiloxane copolymer (A) is 0.1 mass % or more and 60 mass % or less.

12. The polycarbonate-based resin composition according to claim 1, wherein the polycarbonate-polyorganosiloxane copolymer (A) has a viscosity-average molecular weight (Mv) of 5,000 or more and 50,000 or less.

13. The polycarbonate-based resin composition according to claim 1, wherein a molded piece having a total length of 75 mm, a parallel-portion length of 30 mm, an end-portion width of 10 mm, a central parallel-portion width of 5 mm, and a thickness of 2 mm of a JIS K 7139:2009 dumbbell-shaped tensile test piece type A22, which is obtained by molding the polycarbonate-based resin composition, has a tensile modulus of elasticity of 2,400 MPa or more, which is measured under conditions of a tensile rate of 25 mm/min, a measurement temperature of 23° C., and a chuck-to-chuck distance of 57 mm.

14. The polycarbonate-based resin composition according to claim 1, wherein a molded piece having a total length of 75 mm, a parallel-portion length of 30 mm, an end-portion width of 10 mm, a central parallel-portion width of 5 mm, and a thickness of 2 mm of a JIS K 7139:2009 dumbbell-shaped tensile test piece type A22, which is obtained by molding the polycarbonate-based resin composition, has a tensile yield stress of 45 MPa or more, which is measured under conditions of a tensile rate of 25 mm/min, a measurement temperature of 23° C., and a chuck-to-chuck distance of 57 mm.

15. The polycarbonate-based resin composition according to claim 1, wherein a content of the release agent (B) is 0.001 part by mass or more and 2.0 parts by mass or less with respect to 100 parts by mass of the polycarbonate-based resin (S).

16. The polycarbonate-based resin composition according to claim 1, wherein the release agent (B) contains an ester of an aliphatic carboxylic acid and an alcohol.

17. The polycarbonate-based resin composition according to claim 1, wherein the release agent (B) contains at least one kind selected from the group consisting of: an ester of an aliphatic carboxylic acid and pentaerythritol; and an ester of an aliphatic carboxylic acid and glycerin.

18. The polycarbonate-based resin composition according to claim 1, wherein the polycarbonate-polyorganosiloxane copolymer (A) is a copolymer obtained by a melt polymerization method.

19. The polycarbonate-based resin composition according to claim 1, wherein the polycarbonate-polyorganosiloxane copolymer (A) is a copolymer obtained by using a diol monomer (a1).

20. A molded body, comprising the polycarbonate-based resin composition of claim 1.
